(19) United States
(12) Patent Application Publication
(10) Pub. No.: US 2026/0278893 A1
(43) Pub. Date: Sep. 17, 2026

(54) SYSTEMS AND METHODS FOR IMAGE RECONSTRUCTION

(71) Applicant: SHANGHAI UNITED IMAGING HEALTHCARE CO., LTD., Shanghai (CN)

(72) Inventors: Huifang XIE, Shanghai (CN); Yang LYU, Shanghai (CN); Yun DONG, Shanghai (CN)

(73) Assignee: SHANGHAI UNITED IMAGING HEALTHCARE CO., LTD., Shanghai (CN)

(21) Appl. No.: 19/341,224

(22) Filed: Sep. 26, 2025

(30) Foreign Application Priority Data
Sep. 26, 2024 (CN) 202411356361.X
Nov. 22, 2024 (CN) 202411688958.4

(51) Int. Cl. G06T 12/30

(52) U.S. Cl. CPC G06T 12/30; G06T 2211/424; G06T 2211/441

(57) ABSTRACT

A system for image reconstruction is provided. The system, comprising: at least one storage device including a set of instructions; and at least one processor configured to communicate with the at least one storage device. When executing the set of instructions, the at least one processor is configured to direct the system to perform operations including obtaining image data of a subject; performing, based on the image data, an iterative reconstruction process including a plurality of iterations. A candidate image is generated based on the image data according to at least one of the plurality of iterations. The operations further include generating, based on the candidate image, a predicted result using a trained machine learning model, and generating a target image of the subject based on the candidate image and the predicted result. The predicted result indicates a convergence of the iterative reconstruction process;

### CROSS-REFERENCE TO RELATED APPLICATION

The present application claims priority to Chinese Patent Application No. 202411356361.X, filed on Sep. 26, 2024, and Chinese Patent Application No. 202411688958.4, filed on Nov. 22, 2024, the entire contents of each of which are hereby incorporated by reference.

### TECHNICAL FIELD

This present disclosure relates to the field of magnetic resonance technology, and in particular relates to systems and methods, for image reconstruction.

### BACKGROUND

In the medical field, it is necessary to reconstruct a corresponding a reconstructed image from a scanned emission tomography dataset. A conventional Positron Emission Tomography (PET)/Single-Photon Emission Computed Tomography (SPECT) image reconstruction commonly employs an iterative algorithm such as an Ordered-Subsets Expectation-Maximization (OSEM) algorithm or a Maximum-Likelihood Expectation-Maximization (MLEM) algorithm to perform a uniform iterative update on all pixels or an entire image. Since no distinction is made between an anatomical structure and a lesion region, the iterative algorithm requires many iterations to converge in a low-contrast and small region, while computational power is wasted in a high-contrast and large region, and needs an excessively long overall reconstruction time, making it difficult to meet clinical demands for low-dose, and high-throughput imaging.

Therefore, it is desirable to provide systems and methods for image reconstruction to accelerate a convergence speed of the image region and improve an accuracy of the regional image.

### SUMMARY

An aspect of the present disclosure provides a system for image reconstruction. The system may include at least one storage device including a set of instructions, and at least one processor configured to communicate with the at least one storage device. When executing the set of instructions, the at least one processor may be configured to direct the system to perform operations including: obtaining image data of a subject and performing, based on the image data, an iterative reconstruction process including a plurality of iterations. A candidate image is generated based on the image data according to at least one of the plurality of iterations. The operations further include: generating, based on the candidate image, a predicted result using a first trained machine learning model and generating a target image of the subject based on the candidate image and the predicted result. The predicted result indicating a convergence of the iterative reconstruction process.

An aspect of the present disclosure provide a method for image reconstruction. The method may include: obtaining image data of a subject and performing, based on the image data, an iterative reconstruction process including a plurality of iterations. A candidate image is generated based on the image data according to at least one of the plurality of iterations. The method further include: generating, based on the candidate image, a predicted result using a first trained machine learning model and generating a target image of the subject based on the candidate image and the predicted result. The predicted result indicating a convergence of the iterative reconstruction process.

An aspect of the present disclosure provide a device for image reconstruction. The device may include: at least one processor and at least one memory and the at least one memory is configure to store computer instructions. The at least one processor is configured to execute at least a portion of the computer instructions to perform the method for image reconstruction.

An aspect of the present disclosure provide a computer-readable storage medium. The storage medium stores computer instructions, and when the computer instructions are executed by a processor, the method for image reconstruction is realized.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an application scenario of a system for image reconstruction according to some embodiments of the present disclosure;

FIG. 2 is a schematic diagram illustrating an exemplary electronic device according to some embodiments of the present disclosure;

FIG. 3 is a schematic diagram illustrating another exemplary electronic device according to another embodiment of the present disclosure;

FIG. 4 is a schematic diagram illustrating exemplary modules of an exemplary image reconstruction system according to some embodiments of the present disclosure;

FIG. 5 is a schematic diagram illustrating an exemplary process for image reconstruction according to some embodiments of the present disclosure;

FIG. 6 is a schematic diagram illustrating an exemplary process of generating a target image of a subject based on a convergence degree according to some embodiments of the present disclosure;

FIG. 7 is a schematic diagram illustrating an exemplary process of generating a target image of a subject based on a confidence interval of a convergence degree according to some embodiments of the present disclosure;

FIG. 8 is a schematic diagram illustrating an exemplary diagram of determining a target image of a subject according to some embodiments of the present disclosure;

FIG. 9 is a schematic diagram illustrating an exemplary diagram of a first trained machine learning model according to some embodiments of the present disclosure;

FIG. 10 is a schematic diagram illustrating an exemplary diagram of using a first trained machine learning model according to some embodiments of the present disclosure;

FIG. 11 is a schematic diagram illustrating an exemplary iterative reconstruction process according to some embodiments of the present disclosure;

FIG. 12 is a schematic diagram illustrating an overall exemplary process for image reconstruction according to some embodiments of the present disclosure; and

FIG. 13 is a schematic diagram illustrating an overall exemplary diagram of a method for image reconstruction according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device,” “unit,” and/or “module” as used herein is a manner used to distinguish different components, elements, parts, sections, or assemblies at different levels. However, if other words serve the same purpose, the words may be replaced by other expressions.

As shown in the present disclosure and claims, the words “one,” “a,” “a kind,” and/or “the” are not especially singular but may include the plural unless the context expressly suggests otherwise. In general, the terms “comprise,” “comprises,” “comprising,” “include,” “includes,” and/or “including” merely prompt to include operations and elements that have been clearly identified, and these operations and elements do not constitute an exclusive listing. The methods or devices may also include other operations or elements.

Flowcharts are used in the present disclosure to illustrate operations performed by a system according to embodiments of the present disclosure. It should be understood that preceding or succeeding operations are not necessarily executed in a precise order. Instead, various steps may be processed in a reverse order or simultaneously. At the same time, other operations may be added to these processes, or one or more steps may be removed from these processes.

In the technical field of medical imaging, various image reconstruction algorithms, such as an Ordered Subsets Expectation Maximization (OSEM) algorithm, a Maximum-Likelihood Expectation-Maximization (MLEM) algorithm or regularization, are commonly used to obtain a low-noise reconstructed image suitable for clinical diagnosis under a limited count of iterations. However, pixel values in certain regions in a reconstructed image often have not converged to their true values, and the quantitative accuracy of these regions will directly affect a lesion diagnosis result. Therefore, how to quantify a convergence degree in image reconstruction to provide a reference for accurate diagnosis of the lesion has become a technical problem to be addressed by persons skilled in the art.

In some current embodiments, a deep learning model may be used to predict pixel values or determine convergence during an iterative reconstruction process. However, these solutions only use a single intermediate image as a network input and cannot comprehensively utilize multidimensional prior information such as reconstruction algorithm parameters, a count of a plurality of iterations, subject physiological information, and a scanning protocol, resulting in poor generalization capabilities of the deep learning model across different devices and across protocols. Additionally, the lack of a quantitative indicator for assessing lesion region heterogeneity and global information entropy makes it difficult to adaptively adjust a processing strategy in an early iteration stage, potentially leading to either excessive or insufficient iterations. Convergence degree assessments only provide whole-image assessments results and fail to provide region-level confidence intervals, causing a difficulty for a doctor to determine whether a local lesion has reliably converged. Embodiments of the present disclosure provide a system, a method, a device, and a storage medium for image reconstruction, which achieve a quantitative calculation of a convergence degree in image reconstruction by training a deep learning network. For more specific technical implementation details of the embodiments of the present disclosure, refer to the method embodiments described below.

It should be understood that an executing subject of the various method embodiments of the present disclosure may be various types of electronic devices, for example, a desktop computer, a tablet computer, a mobile phone, a wearable device, an augmented reality (AR)/virtual reality (VR) device, a laptop computer, a netbook, a personal digital assistant (PDA), a medical diagnostic device, and the like. The embodiments of the present disclosure do not impose any specific restrictions on the specific type of the electronic device.

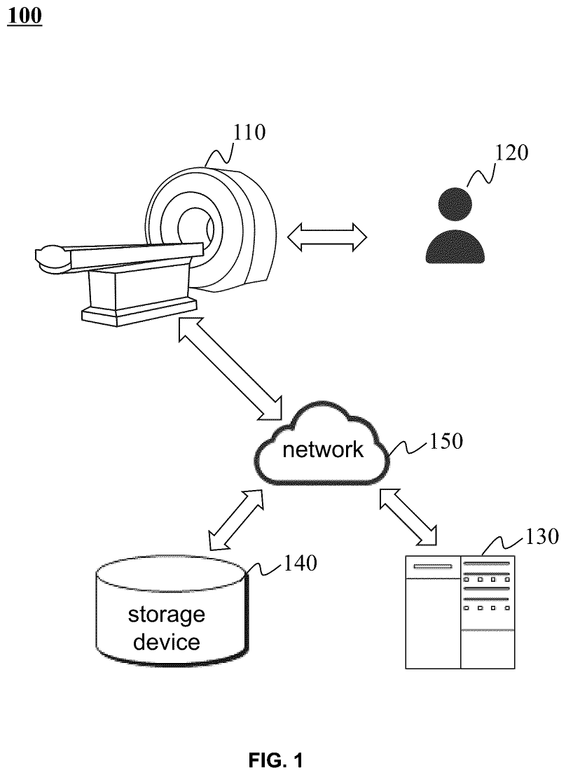

FIG. 1 is a schematic diagram illustrating an application scenario of a system for image reconstruction according to some embodiments of the present disclosure. The method for image reconstruction provided in the embodiments of the present disclosure may be applied in an application environment 100 as shown in FIG. 1.

In some embodiments, as shown in FIG. 1, the application scenario 100 may include an imaging device 110, a subject 120, a processor 130, a storage device 140, and a network 150.

In some embodiments, one or more components in the application environment 100 may transmit data to other components of the application environment 100 via the network 150. For example, the processor 130 may obtain relevant information and/or data of the subject 120 from the imaging device 110 and the storage device 140 via the network 150, or may send information and/or data to the imaging device 110 and the storage device 140 via the network 150.

The imaging device 110 may be used to perform an imaging scan on the subject 120. In some embodiments, the subject 120 may be biological or non-biological. For example, the subject 120 may include a human body, an artificial object, etc. In some embodiments, the subject 120 may include a specific part of a body, for example, the head, the neck, the chest, etc., or any combination thereof. In some embodiments, the subject 120 may include a specific organ, for example, the liver, the kidney, the pancreas, the bladder, the uterus, the rectum, etc., or any combination thereof. In some embodiments, the subject 120 may include a region of interest (ROI), for example, a tumor, a nodule, etc.

In some embodiments, the processor 130 and/or the storage device 140 may be a part of the imaging device 110.

In some embodiments, the imaging device 110 may include a medical imaging device, for example, an X-ray imaging device, a digital radiography (DR) device, a computed radiography (CR) device, a digital fluorography (DF) device, a biochemical immunoassay analyzer, a Computed Tomography (CT) device, a Magnetic Resonance Imaging (MR) device, a Positron Emission Tomography (PET) imaging device, an Emission Computed Tomography (ECT) device, a digital subtraction angiography (DSA) device, an electrocardiogramachine, a C-arm device, an ultrasound imaging device, a fluoroscopic imaging device, etc., or any combination thereof. In some embodiments, the imaging device 110 may include an industrial imaging device, for example, an optical imaging device, an X-ray Digital Radiograph (DR) imaging device, an Industrial Computed Tomography (ICT) device, and other imaging devices. In some embodiments, the imaging device 110 may send image data of the subject 120 to the processor 130 and/or the storage device 140 for further processing via the network 150.

The above description regarding the imaging device 110 is for illustrative purposes only, and is not intended to limit the scope of the present disclosure.

The processor 130 may be used to process data from one or more components in the application scenario 100 or from an external data source. The processor 130 may execute program instructions based on the data, the information, and/or a processing result to perform one or more functions described in the embodiments of the present disclosure. For example, the processor 130 may be used to receive data and information from the imaging device 110. As another example, the processor 130 may be used to send a control instruction (e.g., a power-on instruction, a power-off instruction, a pre-heating instruction, etc.) to the imaging device 110.

In some embodiments, the processor 130 may be a single server or a server group, and the server group may be centralized or distributed. In some embodiments, the processor 130 may be local or remote. In some embodiments, the processor 130 may include a central processing unit (CPU), an application-specific integrated circuit (ASIC), an application-specific instruction-set processor (ASIP), a graphics processing unit (GPU), a physics processing unit (PPU), a digital signal processor (DSP), a processor, a microprocessor unit, a reduced instruction set computer (RISC), a microprocessor, etc., or any combination thereof. In some embodiments, the processor 130 may be integrated in an operating console of the imaging device 110. In some embodiments, the processor 130 may be implemented on a cloud platform. Merely by way of example, the cloud platform may include a private cloud, a public cloud, a hybrid cloud, a community cloud, a distributed cloud, an inter-cloud, a multi-cloud, etc., or any combination thereof.

The storage device 140 is used for storing data, instructions, and/or any other information. In some embodiments, the storage device 140 may store data and/or information sent or acquired by the imaging device 110 and the processor 130 (e.g., MRI images, radiofrequency coil port parameters, etc.). In some embodiments, the storage device 140 may store data and/or instructions used by the processor 130 to perform or use to complete the exemplary methods described in the present disclosure. In some embodiments, the storage device 140 may include a mass storage, a removable storage, etc., or any combination thereof. In some embodiments, the storage device 140 may be integrated into the processor 130.

The network 150 may be any suitable network capable of facilitating an exchange of information and/or data. In some embodiments, the network 150 may be any one or more of a wired network or a wireless network. The network 150 may include one or more network access points. Through the network access points, one or more components in the application scenario 100 may connect to the network 150 to exchange data and/or information. In some embodiments, the network 150 may have various topological structures such as a point-to-point, a shared, a centralized structure, etc., or a combination of a plurality of topological structures.

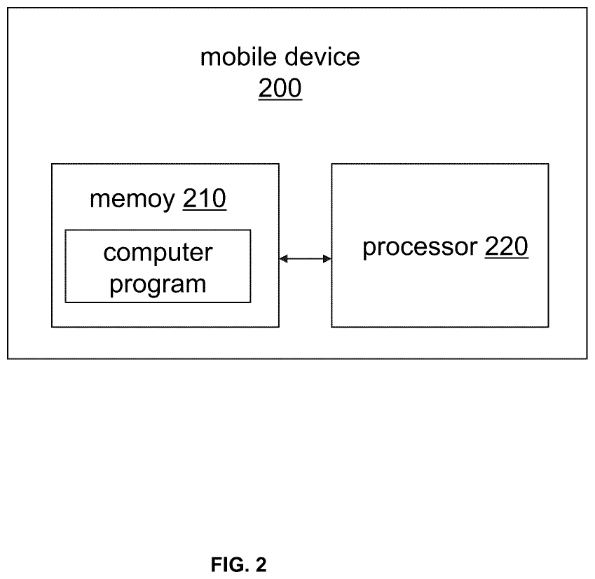

For more content regarding the above-mentioned components may be found in FIGS. 2-13 and their related descriptions.

It should be noted that the application scenario 100 of the system for image reconstruction is provided for illustrative purposes only and is not intended to limit the scope of the present disclosure. For a person of ordinary skill in the art, various modifications or variations may be made according to the description of the present disclosure. However, such variations and modifications do not depart from the scope of the present disclosure.

FIG. 2 is a schematic diagram illustrating an exemplary electronic device according to some embodiments of the present disclosure. In some embodiments, the electronic device is configured to process information related to an optimization of a medical image, and the electronic device may be a mobile device 200. The mobile device 200 may include but is not limited to a smartphone, a tablet computer, a wearable computing device (e.g., glasses, a watch, etc.), and the like. The mobile device 200 may include one or more processors 220 and one or more memories 210. In addition, the mobile device 200 may also include any other suitable component such as a system bus or a controller (not shown in FIG. 2). As shown in FIG. 2, a mobile operating system (e.g., iOS, Android, Windows Phone, etc.) and one or more applications may be loaded from the one or more memories 210 into the one or more processors 220 for execution by the one or more processors 220. The one or more applications may include a browser or other mobile applications for receiving and processing information input into the mobile device 200.

To implement the various modules, units, and their functions described above, a computer hardware platform may be used as a hardware platform for one or more elements. Since these hardware elements, operating systems, and programming languages are common, it may be assumed that persons skilled in the art are familiar with these technologies and that they can provide the information required for an online-to-offline service based on the techniques described in the present disclosure. A computer with a user interface may be used as a personal computer (PC) or another type of workstation or terminal device. If properly programmed, a computer with a user interface may be used as a server. It may be considered that a person of ordinary skill in the art is also familiar with a structure, a program, or a general operation of this type of computer device. Therefore, no additional explanation is provided for the description of the drawings.

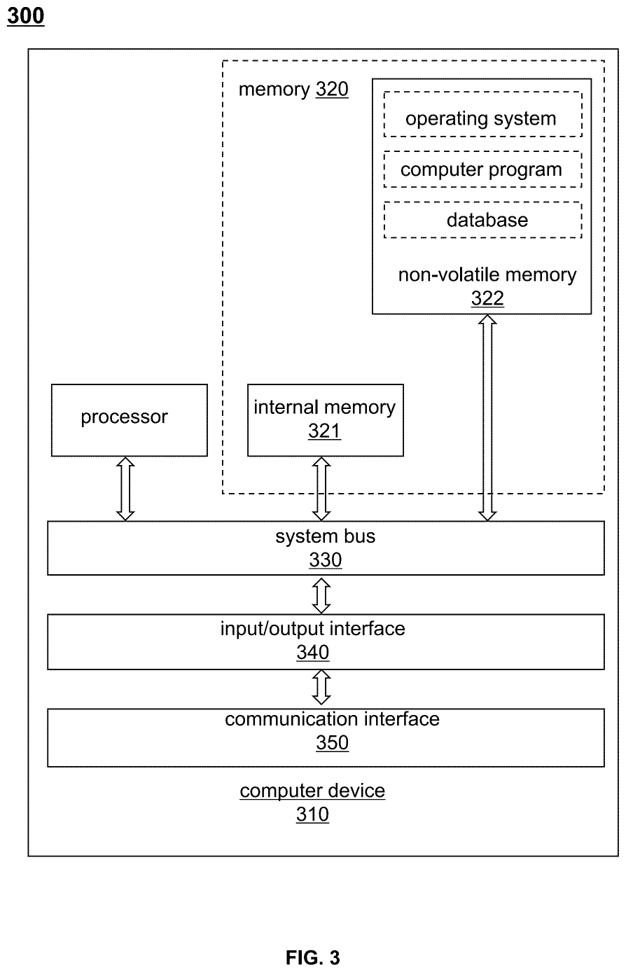

FIG. 3 is a schematic diagram illustrating another exemplary electronic device according to another embodiment of the present disclosure. An electronic device 300 may be configured to perform one or more functions of various modules in an image reconstruction system 400 disclosed in the embodiments of the present disclosure.

The electronic device 300 may be a general-purpose computer or a special-purpose computer, either of which may be used to implement the image reconstruction system 400 of the present disclosure. The electronic device 300 may be used to implement any component of the image reconstruction system 400 as described in the present disclosure. For example, a processor may be implemented on the electronic device 300 through its hardware, a software program, a firmware, or a combination thereof. For convenience, only one computer is shown in the figure, but the computer functions related to an optimization of a medical image described in the present disclosure may be implemented in a distributed manner on a plurality of similar platforms to distribute a processing load.

For example, the electronic device 300 may include a communication interface 350, which is connected to a network and/or from a network to achieve data communication. The electronic device 300 may also include one or more processors in the form of processors for executing program instructions. An exemplary computer device 310 may include a processor, a memory 320 (such as an internal memory 321, a non-volatile memory 322), and a system bus 330. The exemplary computer device 310 also includes a computer program stored in the non-volatile memory 322 and/or another form of non-transitory storage medium to be executed by the processor, an operating system for executing the program, and a database for storing data. The method and/or process of the present disclosure may be implemented in the form of program instructions. The electronic device 300 may also include an input/output interface 340, which may support input/output between the computer and other components. The electronic device 300 may also receive programming and data through a network communication.

Merely for illustration, only one CPU and/or processor is exemplarily described in the electronic device 300. However, it should be noted that the electronic device 300 in the present disclosure may include a plurality of CPUs and/or processors, and therefore, the operations and/or methods described in the present disclosure as being implemented by one CPU and/or processor may also be implemented jointly or independently by a plurality of CPUs and/or processors. For example, if in the present disclosure, the CPU and/or processor of the electronic device 300 performs an operation A and an operation B, it should be understood that the operation A and the operation B may also be performed jointly or independently by two different CPUs and/or processors in the electronic device 300 (e.g., a first processor performs the operation A, a second processor performs the operation B, or the first and second processors jointly perform the operation A and the operation B).

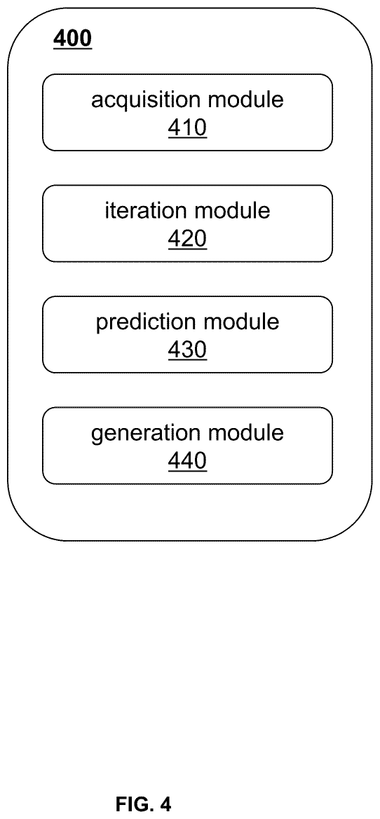

FIG. 4 is a schematic diagram illustrating exemplary modules of an exemplary image reconstruction system according to some embodiments of the present disclosure.

In some embodiments, as shown in FIG. 4, an image reconstruction system 400 may include an acquisition module 410, an iteration module 420, a prediction module 430, and a generation module 440.

In some embodiments, the acquisition module 410 may be configured to: obtain image data of a subject.

In some embodiments, the iteration module 420 may be configured to: perform, based on the image data, an iterative reconstruction process including a plurality of iterations, wherein a candidate image is generated based on the image data according to at least one of the plurality of iterations;

In some embodiments, the prediction module 430 may be configured to: generate, based on the candidate image, a predicted result using a first trained machine learning model, the predicted result indicating a convergence of the iterative reconstruction process; and

In some embodiments, the generation module 440 may be configured to: generate a target image of the subject based on the candidate image and the predicted result.

In some embodiments, the generation module 440 may be further configured to: determine, based on the convergence degree corresponding to each of the at least one region in the candidate image, pixel values in the each of the at least one region in the target image.

In some embodiments, the generation module 440 may be further configured to: in response to determining that the convergence degree corresponding to each of the at least one region in the candidate image satisfies a first condition, terminate the iterative reconstruction process and designate the candidate image as the target image, wherein the target image is a reconstructed image after the iterative reconstruction process; and in response to determining that the convergence degree corresponding to one of the at least one region in the candidate image does not satisfy the first condition, adjust pixel values in the one of the at least one region in the candidate image to generate an updated candidate image according to the convergence degree corresponding to the one of the at least one region in the candidate image, wherein the updated candidate image is designated as an initial image used in the next iteration.

In some embodiments, the generation module 440 may be further configured to: determine an adjustment amplitude for adjusting the pixel values in the one of the at least one region of the candidate image based on the convergence degree corresponding to the one of the at least one region in the candidate image; and adjust the pixel values in the one of the at least one region in the candidate image based on the adjustment amplitude.

In some embodiments, the predicted result includes an estimation value of each of at least a portion of pixels in the candidate image, and the generation module 440 may be further configured to: adjust a pixel value of each of the at least a portion of pixels in the candidate image based on the estimation value of each of the at least a portion of pixels in the candidate image.

In some embodiments, the predicted result includes a confidence interval of a convergence degree corresponding to each of the at least one region in the candidate image, and the generation module 440 may be further configured to: in response to determining that the confidence interval of the convergence degree corresponding to each of the at least one region in the candidate image satisfies a second condition, the iterative reconstruction process and designate the candidate image as the target image; and in response to determining that the confidence interval of the convergence degree corresponding to one of the at least one region in the candidate image does not satisfy the second condition, perform a next iteration of the at least one iteration, and designate the candidate image as an initial image used in the next iteration.

In some embodiments, the predicted result includes a convergence degree corresponding to each of at least one region in the candidate image, an estimation value of each of at least one pixel in the candidate image, or a confidence interval of a convergence degree corresponding to each of at least one region in the candidate image, and the generation module 440 may be further configured to: determine one or more state characteristics of the candidate image, where the one or more state characteristics include at least one of a global image entropy or a lesion heterogeneity value; determine a target processing strategy from a plurality of reference processing strategies based on the one or more state characteristics; and process the candidate image using the target processing strategy to generate the target image.

In some embodiments, the generation module 440 may be further configured to: in response to determining that the global image entropy is less than a first threshold, and the lesion heterogeneity value is less than a second threshold, adjust a pixel value of each of the at least a portion of pixels in the candidate image based on the estimation value of each of the at least a portion of pixels in the candidate image; in response to determining that the global image entropy is less than a first threshold, and the lesion heterogeneity value exceeds or equals the second threshold, determine the target image based on the confidence interval of the convergence degree corresponding to each of at least one region in the candidate image; and in response to determining that the global image entropy exceeds the first threshold, determine the target image based on the convergence degree corresponding to each of at least one region in the candidate image.

It should be noted that the above descriptions of the image reconstruction system 400 and its modules are for convenience of description only and do not limit the present disclosure to the scope of the illustrated embodiments. It may be understood that for persons skilled in the art, after understanding a principle of the devices, the various modules may be arbitrarily combined, or constituted as a sub-devices to connect with other modules without departing from this principle. In some embodiments, the acquisition module 410, the iteration module 420, the prediction module 430, and the generation module 440 in FIG. 4 may be different modules in one device, or one module may implement the functions of two or more of the above-mentioned modules. For example, the various modules may share one storage module, or each module may have its own storage module. Such variations are all within the protection scope of the present disclosure.

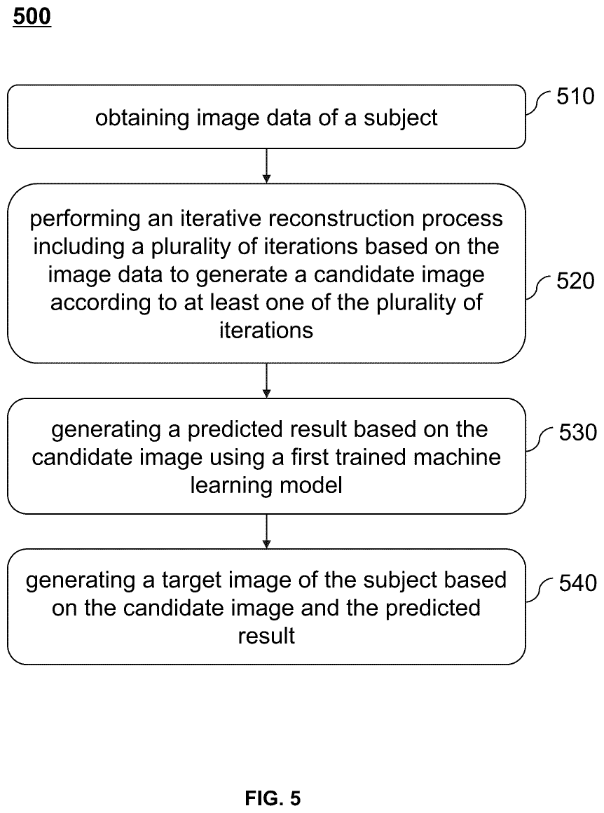

FIG. 5 is a schematic diagram illustrating an exemplary process for image reconstruction according to some embodiments of the present disclosure; In some embodiments, a process 500 may be performed by a processor (e.g., the processor 130). In some embodiments, a process 500 may be performed by the image reconstruction system 400. The process 500 may include operations 510-540.

In 510, image data of a subject may be obtained. In some embodiments, operation 510 may be performed by the acquisition module 410.

The image data refers to scan data of the subject used for the image reconstruction.

In some embodiments, the image data may include Magnetic Resonance Imaging (MRI) data, Computed Tomography (CT) data, Single-Photon Emission Computed Tomography (SPECT) data, Positron Emission Tomography (PET) data, or the like, or a combination thereof.

The processor may receive the image data sent from an imaging device (e.g., a PET/CT scanner, a SPECT scanner), or may obtain the image data from a storage device.

In 520, an iterative reconstruction process including a plurality of iterations may be performed based on the image data. A candidate image may be generated based on the image data according to at least one of the plurality of iterations.

In some embodiments, the candidate image refers to an intermediate image used for further correction and optimization generated in at least one iteration during the iterative reconstruction process. For example, the candidate image generated in a first iteration of the iterative reconstruction process may be obtained by performing an initial iteration based on the image data, and a candidate image generated in an N-th iteration (N>1) may be obtained by performing N iterations based on the image data.

Exemplarily, the processor may obtain the candidate image based on the image data using a preset reconstruction algorithm. The preset reconstruction algorithm includes a back-projection algorithm, a maximum likelihood expectation maximization (MLEM) algorithm, etc. For example, using the MLEM algorithm, in each iteration, an initial image may be obtained, a back-projection may be performed on the initial image to generate image data estimation corresponding to the initial image, and the image data estimation is compared with the image data to determine whether a difference between the image data estimation and the image data meets a preset standard. In response to determining that the difference between the image data estimation and the image data does not satisfy the preset standard, the initial image is adjusted to obtain a target image such that the image data estimation corresponding to the target image approaches the image data (i.e., making the difference between the image data estimation corresponding to the initial image and the image data satisfy the preset standard). The reconstructed image may be designated as the initial image for a next iteration. The reconstructed image generated in each of the at least one iteration is designated as the candidate image,

In some embodiments, the processor may obtain supplementary Information and perform each of at least a portion of the plurality of iterations based on the image data according to the supplementary Information to obtain the candidate image. The supplementary Information may be used to indicate how to perform an iterative reconstruction processing on the image data. The processor may obtain the supplementary Information input by a user, or may receive the supplementary Information sent by another device.

The supplementary information may include subject information, imaging device information, scanning protocol information, reconstruction algorithm information, or the like, or a combination thereof. The subject information may include physiological information of the subject, for example, including a gender, height, blood glucose data, etc., of the subject. The imaging device information may include attribute information of the imaging device, for example, a model, a size, etc., of a detector in the imaging device. The scanning protocol information may include a scan type, a scan time, a scan part, etc., of the imaging device. The reconstruction algorithm information may include a preset reconstruction algorithm used in the iterative reconstruction process.

In some embodiments, the supplementary Information may also include a reference iteration parameter and the initial image used in the first iteration of the iterative reconstructed image. The reference iteration parameter may include a count of the plurality of iterations of the iterative reconstruction process, a type of a reconstruction algorithm used in the iterative reconstruction process, etc. In some embodiments, the initial image in the first iteration may be an image with all pixel values being 1. In some embodiments, the initial image in the first iteration may be an image generated based on an image with all pixel values being 1. For example, the initial image in the first iteration may be an image by adjusting one or more pixel values in the image with all pixel values being 1.

In some embodiments, the candidate image may be obtained after performing the specific count of iterations in the plurality of iterations. For example, the processor may perform 50 iterations based on the image data and the preset reconstruction algorithm in the supplementary Information to obtain the candidate image before the 51-st iteration is performed (i.e., the initial image in the 51-st iteration). The candidate image generated before the 51-st iteration may be denoted as an image a.

In some embodiments, the at least one iteration may be a specific iteration among the plurality of iterations. For example, the at least one iteration may be the 50-st iteration among the plurality of iterations as described above. As another example, the at least one iteration may include an iteration after every 2 iterations in the plurality of iterations, an iteration after every 3 iterations in the plurality of iterations, etc.

In some embodiments, the at least one iteration may include each iteration among the plurality of iterations. In other words, the reconstructed image generated in each iteration may be designated as the candidate image.

In some embodiments, the at least one iteration may be the last iteration among the plurality of iterations. In other words, the candidate image may be the reconstructed image generated in the last iteration of the iterative reconstruction process.

The processor may generate the candidate image based on the image data according to the at least one of the plurality of iterations, and generate a predicted result using a first trained machine learning model based on the candidate image. In the embodiment, the predicted result may be a convergence degree of the candidate image. For more description of the convergence degree, see operation 530 and its related description.

In some embodiments, the at least one iteration is the last iteration of the iterative reconstruction process, and the processor may determine the convergence degree of the reconstructed image (i.e., the candidate image) generated in the last iteration.

In some embodiments of the present disclosure, in response to determining that the at least one iteration is the last iteration of the iterative reconstruction process, it can be beneficial for reducing a computational complexity of a neural network model, reducing resource consumption, and ensuring a final image quality.

In some embodiments, the at least one iteration includes a target iteration, and the target iteration is determined based on a difference between reconstructed images generated in adjacent iterations in already performed iterations of the iterative reconstruction process and a count of the already performed iterations. If the at least one iteration is the target iteration among the iterative reconstruction process, the processor may determine the convergence degree of the reconstructed image (i.e., the candidate image) generated in the target iteration.

The “adjacent iterations” refer to the two most recently completed iterations. For example, upon the completion of an N-th iteration, the difference between reconstructed images generated in adjacent iterations may be determined between the reconstructed image generated in the N-th iteration and the reconstructed image generated in the (N−1)th iteration. This ensures the determination is based on the most current convergence behavior.

The difference between the reconstructed images generated in the adjacent iterations may be a pixel difference between the reconstructed images generated in the adjacent iterations. In some embodiments, the processor may use an average of absolute differences each of which is between corresponding two pixels at each pixel position of the two reconstructed images generated in the adjacent iterations as the difference between the reconstructed images generated in the adjacent iterations.

In some embodiments, during the iterative reconstruction process is performed, after the count of already performed iterations is greater than a count threshold (also referred to as the first count threshold), if the difference of a certain pair of adjacent iterations (the two most recently completed iterations) is greater than a difference threshold, then the next iteration of the pair of adjacent iterations may be determined as the target iteration. The difference threshold and the count threshold may be a system default value, an empirical value, a value pre-set by a human, or any combination thereof, and may be set according to actual needs. It should be noted that the computation of a machine learning model (especially an inference of a neural network) is resource-intensive. Calling the machine learning model in an early stage of the iterative reconstruction process (when an image is still chaotic) or a late stage (when the image has basically converged) of the iterative reconstruction process will waste computing resources. In some embodiments of the present disclosure, the target iteration may be determined based on the difference between adjacent iterations in the iterative reconstruction process and the count of already performed iterations, and the convergence degree of the reconstructed image generated in the target iteration may be determined. Thus, when the difference between adjacent iterations is significant (indicating that the efficiency of the iterative reconstruction process is low and an external boost is most needed for facilitate the convergence of the iterative reconstruction process, thereby accelerating the iterative reconstruction process), the machine learning model can be used to determine the convergence degree, thereby achieving a maximum acceleration effect with a minimum count of interventions.

In some embodiments, the processor may determine the count threshold based on a lesion size of the subject.

In some embodiments, the processor may determine the lesion size through any other feasible detection manner (e.g., by identifying from a CT image). The smaller the lesion size, the larger the count threshold.

The task of the count threshold is to screen out an intense but meaningless structural fluctuation that occurs during the process of a reconstructed image transitioning from chaos to order in the early stages of the iterative reconstruction process (usually 1st-3rd iterations), ensuring that a system only starts monitoring a target image generated after the reconstructed image has entered a relatively stable and analyzable stage. For a smaller lesion, the signal of the smaller lesion is very weak, and in the early stage of the iterative reconstruction process, changes in the signal are completely overwhelmed by a drastic change in a large organ or a high-activity region. If monitoring starts too early, the system will make a premature and incorrect judgment due to a “noise” from another region in a uncovered image, so the count threshold should be increased in a case of a smaller prior lesion size.

In some embodiments, the count of the plurality of iterations is less than a second count threshold. In some embodiments, the count of the plurality of iterations may be preset by a technician based on experience. The count of the plurality of iterations refers to a total count of iterations when generating the target image. The second count threshold may be a system default setting or preset by a technician based on experience. The second count threshold may exceed to the first count threshold.

In 530, based on the candidate image, a predicted result may be generated using the first trained machine learning model.

The predicted result indicates a convergence of the iterative reconstruction process or a pixel value estimation of the candidate image.

In some embodiments, the predicted result may include a convergence degree corresponding to the candidate image.

The convergence degree refers to a parameter that characterizes a difference between the candidate image and a benchmark image. The benchmark image may be a reconstructed image when the pixel values of the reconstructed image converge to close to or the same as the actual values. For example, the convergence degree may be a difference in pixel values between the candidate image and the benchmark image.

In some embodiments, the processor may perform a reference iterative reconstruction process including a large count of the plurality of iterations (e.g., more than 50 times) based on reference image data with a sufficient data amount to obtain the benchmark image. During an acquisition of the reference image data, the sufficient amount of the reference image data may be collected by increasing a scanning time, improving a scanning sensitivity, and so on.

In some embodiments, the convergence degree may be represented as a difference in pixel values or a ratio of pixel values between the candidate image and the benchmark image.

In some embodiments, the candidate image may include one or more first regions and the benchmark image may include one or more second regions. Each of the one or more first regions may correspond to one of the one or more second regions. Corresponding first region and second region may represent the same portion of the subject. For each first region and a corresponding second region, the processor may determine a difference in pixel values or a ratio of pixel values between the first region in the candidate image and the corresponding second region in the benchmark image and determine the convergence degree based on the differences (or ratios) each of which is between a first region and a corresponding second region. For example, for each first region among the one or more first regions in the candidate image, the processor may determine a difference or a ratio of pixel values between the first region and the corresponding second region in the benchmark image as a candidate convergence degree corresponding to the first region. The convergence degree corresponding to the candidate image may be a mean, a median, or a mode of the candidate convergence degrees corresponding to the one or more first regions in the candidate image. A difference of pixel values between the first region and the corresponding second region may be an average of differences, each of which is between a pixel value in the first region and a corresponding pixel value in the second region. A ratio of pixel values between the first region and the corresponding second region may be an average of ratios, each of which is between a pixel value in the first region and a corresponding pixel value in the second region.

In some embodiments, the processor may generate the predicted result based on the candidate image through the first trained machine learning model. For example, before a current iteration is performed, the processor may input the candidate image into the first trained machine learning model, and the first trained machine learning model may perform feature extraction based on the candidate image and output the convergence degree of the candidate image.

In some embodiments, the candidate image may be pre-processed to obtain the pre-processed candidate image and the pre-processed candidate image may be input to the first trained machine learning model. For example, after the processor obtains the candidate image after performing the initial iteration or several iterations based on the image data, the processor may pre-process the candidate image and use the pre-processed candidate image as an input to the first trained machine learning model. The pre-processing includes smoothing processing, enhancement processing, fusion processing with other anatomical images, etc., or the combination thereof

In some embodiments, a fused image may be generated after fusion processing based on the candidate image and the fused image may be input to the first trained machine learning model.

In some embodiments, the fused image may be generated by fusing a functional image (i.e., the candidate image) and an anatomical image, where the functional image and the anatomical image correspond to the same detection subject. In this embodiment, the processor may perform the initial iteration or the plurality of iterations based on the image data to obtain the functional image (i.e., the candidate image). Further, the processor may also obtain the anatomical image corresponding to the same detection subject as the functional image. The functional image and the anatomical image may be images acquired from the same detection subject at different times or the same time.

The anatomical image is an image that may characterize anatomical features of the detection subject. For example, the anatomical image may be a Computed Tomography (CT) image, a Magnetic Resonance (MR) image, etc.

Furthermore, the processor may then perform fusion processing on the functional image and the anatomical image to obtain the fused image. Exemplarily, the processor may perform the fusion processing on the functional image and the anatomical image by means of layer stacking, function weighting, multiply blending, etc.

In the above embodiment, since the fused image is generated by fusing the functional image and the anatomical image, the functional image and the anatomical image correspond to the same detection subject, and the functional image may be obtained through the initial iteration or the plurality of iterations of the image data, the fused image can provide more comprehensive information, which is beneficial for accelerating convergence.

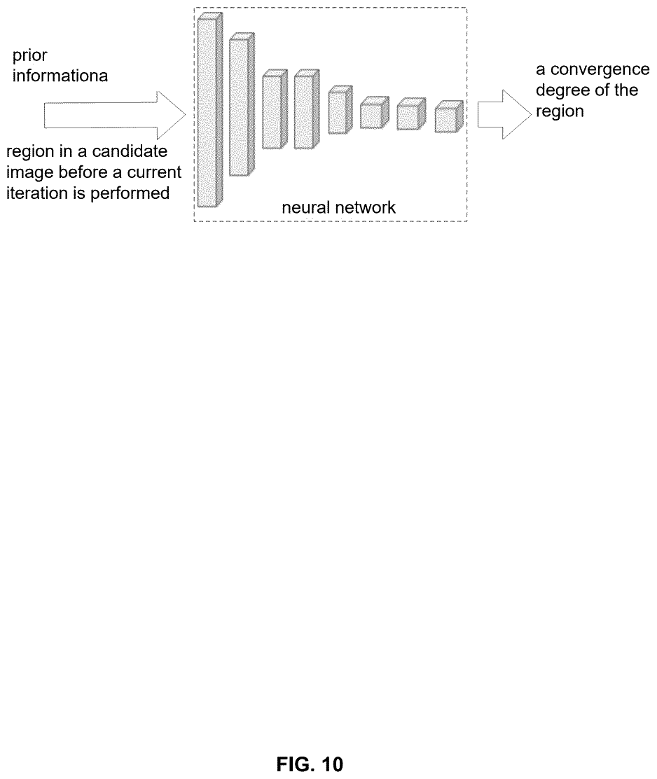

FIG. 10 is a schematic diagram illustrating an exemplary diagram of using a first trained machine learning model according to some embodiments of the present disclosure.

For example, as shown in FIG. 10, a processor may input the at least one region in the candidate image generated in at least one iteration (e.g., a candidate image generated in a current iteration, a candidate image generated in a target iteration, or a candidate image generated in a last iteration) into the first trained machine learning model. The first trained machine learning model may perform feature extraction from the at least one region in the candidate image to output the convergence degree corresponding to each of the at least one region in the candidate image.

In some embodiments, the processor may also input prior information and the at least one region in the candidate image into the first trained machine learning model. The first trained machine learning model may execute processing based on the prior information and the at least one region in the candidate image to output the convergence degree corresponding to each of the at least one region in the candidate image.

Taking a lesion region of an F18-fluorodeoxyglucose (F18-FDG) image (i.e., the candidate image) as an example, the processor may input the lesion region, a medical history of patient, and prior information such as the size and shape of the lesion into the first trained machine learning model, so that the first trained machine learning model outputs a convergence degree corresponding to the lesion region.

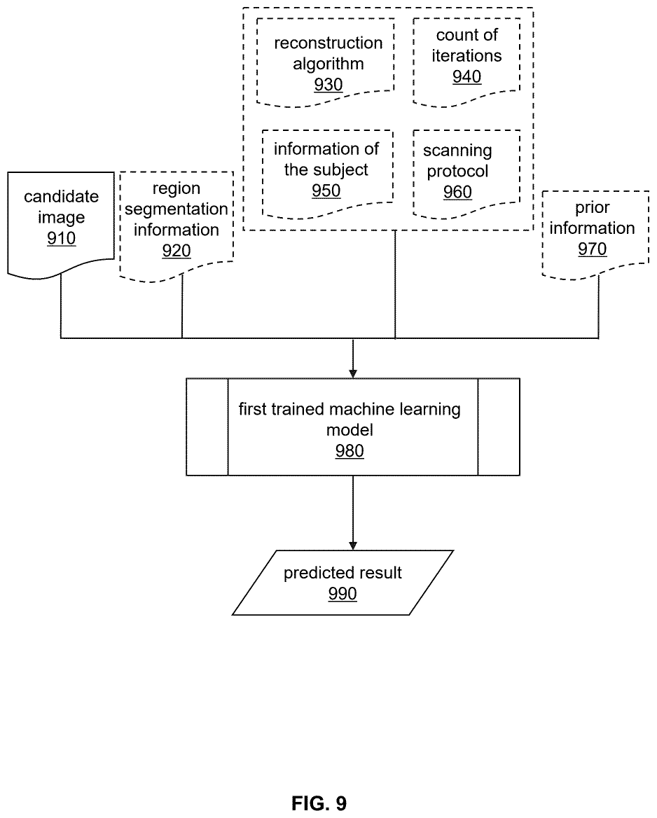

For more content about the first trained machine learning model, see FIG. 9 and its related description.

In 540, a target image of the subject may be generated based on the candidate image and the predicted result.

The target image refers to an image finally outputted after the image reconstruction process.

In some embodiments, the processor may adjust the candidate image based on the predicted result and designate the adjusted candidate image as the target image.

In some embodiments, when the predicted result is the convergence degree of the candidate image, the processor may determine whether to continue iterative reconstruction process based on the candidate image according to the convergence degree of the candidate image. The processor may determine whether the convergence degree of the candidate image satisfies a reference condition. If the convergence degree of the candidate image satisfies the reference condition, the candidate image may be designated as the target image and the iterative reconstruction process may be terminated; if the convergence degree of the candidate image does not satisfy the reference condition, the iterative reconstruction process may continue based on the candidate image. The reference condition may be that the convergence degree of the candidate image is greater than or equal to a convergence threshold. The convergence threshold may be a system default value, an empirical value, a pre-set value by a human, or any combination thereof, and may be set according to actual needs.

When the convergence degree of the candidate image satisfies the reference condition, a feature difference between the candidate image and a corresponding target image is very small, and it may be considered that the candidate image has achieved a good image reconstruction effect. Therefore, the candidate image is designated as the reconstructed target image, and then the target image may be output, e.g., for lesion diagnosis.

When the convergence degree of the candidate image does not satisfy the reference condition, the feature difference between the candidate image and the corresponding target image is significant, which indicates that the image reconstruction effect of the candidate image is poor, and it is necessary to continue performing the iterative reconstruction process based on the candidate image to improve the convergence degree of the candidate image. After continue performing iterative reconstruction process and performing several iterations on the candidate image, the first trained machine learning model is used again to obtain the convergence degree of the candidate image, and it is continuously determined whether the convergence degree of the candidate image satisfies the reference condition until a candidate image with a convergence degree that satisfies the reference condition is obtained and output as the target image.

With this setting, the first trained machine learning model can be used to detect a quantitative convergence degree value of the candidate image in real-time during the image reconstruction process, continuously evaluating whether the current convergence degree of the candidate image satisfies the reference condition, and finally, a reconstructed image with a convergence degree that satisfies the reference condition can be conveniently obtained.

In some embodiments, the predicted result may include a pixel value estimation of pixels in the candidate image, the processor may update at least one pixel value in the candidate image based on the pixel value estimation of the pixels in the candidate image to adjust the candidate image. For example, the processor may directly use the pixel value estimation of the pixels as the pixel values in the candidate image to obtain the adjusted candidate image. In some embodiments, the processor may perform activity reconstruction on the adjusted candidate image and then proceed with a next iterative reconstruction. Optionally, the processor may directly designate the adjusted candidate image as the target image.

In some embodiments of the present disclosure, by updating pixel values to obtain the adjusted candidate image, the adjusted candidate image is more conducive to convergence, so the target image can be obtained with a faster convergence speed, improving the convergence speed of obtaining the target image.

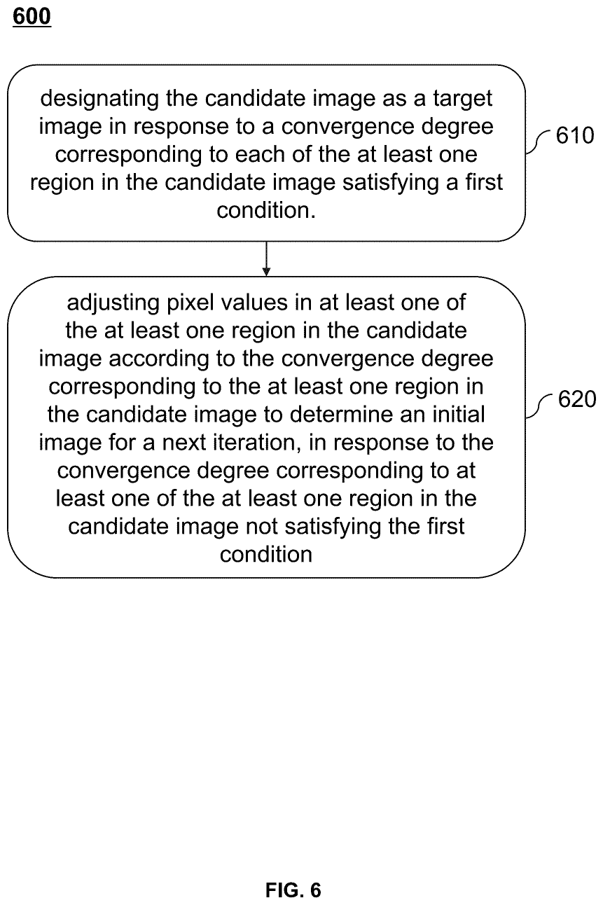

For more details on generating the target image based on the predicted result and the candidate image, refer to the relevant descriptions of FIG. 6-FIG. 9 below.

In some embodiments, the predicted result may include a convergence degree corresponding to each of the at least one region in the candidate image. In some embodiments, the processor may determine the convergence degree corresponding to each of at least one region in the candidate image through the first trained machine learning model based on the at least one region in the candidate image.

In some embodiments, each of the at least one region in the candidate image corresponds to a different anatomical structure or region of interest.

For example, the at least one region in the candidate image may include regions with different lesions in the candidate image.

As another example, the at least one region in the candidate image may include regions where different organs and bones are located in the candidate image.

The processor may segment the candidate image to determine the at least one region in various ways.

In some embodiments, the processor may equally divide the candidate image to obtain the at least one region, or may use a preset algorithm, such as a threshold segmentation algorithm, to determine the at least one region.

In some embodiments, the processor may identify one or more lesions in the candidate image and designate a region where each lesion is located as one region. The embodiments of the present disclosure do not impose special limitations on the manner of identifying lesions; operations familiar to those skilled in the art may be used.

In some embodiments, the processor may determine different regions of interest in the candidate image based on a Multimodal Organ Segmentation Engine (MOOSE) and determine the one or more lesion regions in the candidate image based on a U-shaped network (UNET).

In some embodiments, the processor may segment the candidate image into the at least one region using a machine learning model.

The present disclosure does not limit the manner for determining the at least one region.

It should be noted that an iterative reconstruction process will update the pixel values in the candidate image but will not change a size of the candidate image. Therefore, the processor may only need to determine the at least one region in a candidate image generated in one iteration (e.g., a first iteration), and the positions and sizes of corresponding regions in candidate images from different iterations remain the same.

In some embodiments, each of the at least one region corresponds to a different anatomical structure or region of interest. The anatomical structure includes but is not limited to tissue and organs. The region of interest may be a lesion. Taking the candidate image generated before a current iteration as image a, for example, the processor may use a tool MOOSE to segment an abdominal organ region, a bone structure region, a brain region, and a fat region based on physiological structures in the image a, and use other tools to segment a lesion region to determine 5 regions in the image a.

In some embodiments, the processor may determine pixel values in each of the at least one region in the target image using first machine learning model based on the convergence degree corresponding to each of the at least one region. For example, the processor may determine the pixel values in the at least one region in the target image in response to the convergence degree of the at least one region being below a convergence degree threshold.

After pixel values in the at least one region in the target image is determined, the processor may automatically generate the target image based on the pixel values in the at least one region in the target image.

For more content on determining pixel values, see the detailed description of operation 540 in FIG. 5.

In some embodiments of the present disclosure, determining the pixel values in the at least one region in the target image based on the convergence degree corresponding to each of the at least one region is beneficial for accelerating the iterative reconstruction process of the candidate image, improving reconstruction efficiency, and ensuring the accuracy of the target image, thereby achieving intelligent optimization of pixels in the target image.

In some embodiments, the predicted result may include a convergence degree corresponding to each of the at least one region in the candidate image. The processor may, in response to the convergence degree corresponding to the each of the at least one region satisfying a first condition, designate the candidate image as the target image; in response to the convergence degree corresponding to one of the at least one region in the candidate image not satisfying the first condition, adjust pixel values in the one of the at least one region in the candidate image to determine an initial image for a next iteration.

In some embodiments, the predicted result includes a confidence interval of a convergence degree corresponding to each of the at least one region in the candidate image. The processor may, in response to the confidence interval of the convergence degree corresponding to each of the at least one region in the candidate image satisfying a second condition, designate the candidate image as a reconstructed image; in response to the confidence interval of the convergence degree corresponding to one of the at least one region in the candidate image not satisfying the second condition, designate the candidate image as an initial image for a next iteration.

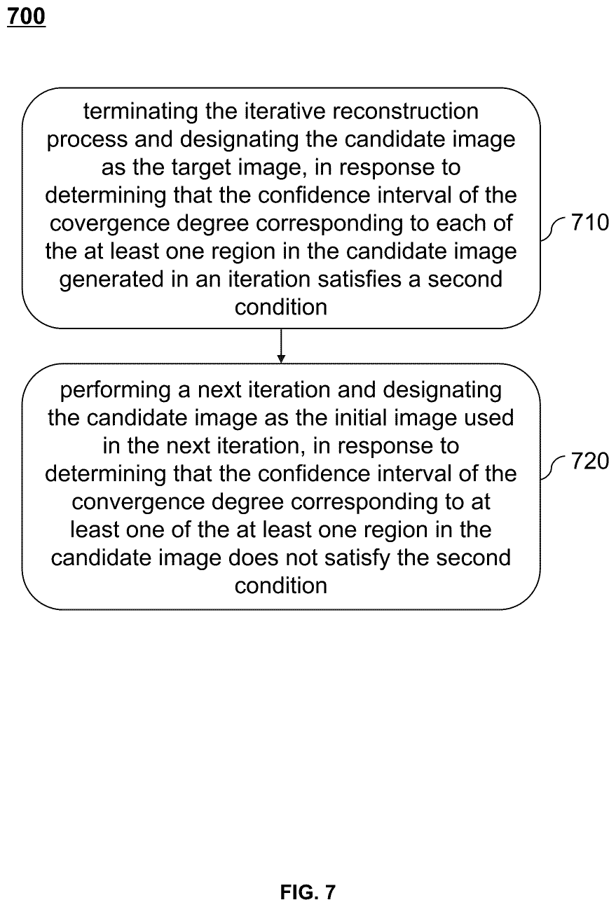

For more content, see the relevant descriptions of FIG. 6 and FIG. 7.

In some embodiments, the predicted result includes an estimation value of each of at least a portion of pixels (also referred to as pixel value estimation) in the candidate image, and the processor may determine the estimation value of each of the at least a portion of pixels in the candidate image through a first trained machine learning model based on the candidate image.

For example, the processor may input the candidate image into the first trained machine learning model, and the first trained machine learning model may perform feature extraction based on the candidate image to output the estimation value of each of the at least a portion of pixels in the candidate image.

In some embodiments, the processor may adjust a pixel value of each of the at least a portion of pixels in the candidate image based on the estimation value of each of the at least a portion of pixels in the candidate image. The candidate image with the pixel value of each of the at least a portion of pixels adjusted may also be referred to as a corrected candidate image (also referred to as an adjusted candidate image).

In some embodiments, the at least a portion of pixels may be each pixel in the candidate image, or may be each pixel in a specific region (such as a lesion region, a region of interest, etc.) of the candidate image.

The estimation value refers to a predicted pixel value in the candidate image (also called a pixel value estimation). The pixel value estimation may represent a pixel value corresponding to a region when it approaches or reaches a converged state, and may also be understood as activity information.

In some embodiments, the processor may determine the pixel value estimation through the first trained machine learning model based on the candidate image. For example, when using the first trained machine learning model, the processor may input the candidate image into the first trained machine learning model, and the first trained machine learning model may perform feature extraction based on the candidate image to output the pixel value estimation of each of the at least a portion of pixels in the candidate image. For more content about the first trained machine learning model, see FIG. 9 and its related description.

In some embodiments, the processor may adjust the pixel value of each of the at least a portion of the pixels in the candidate image in various ways based on the pixel value estimation of each of the at least a portion of pixels in the candidate image. Taking region A in candidate image a as an example, the processor may update a pixel value of the pixel in the region A of candidate image a with the pixel value estimation of the pixel in the region A in the candidate image a to obtain a corrected candidate image a.

For example, the processor may directly use the pixel value estimation or convergence degree corresponding to the at least one pixel as the pixel value or convergence degree at a corresponding pixel position, respectively.

As another example, the processor may update some pixel values with the pixel value estimation, while the remaining pixel values are adjusted based on the convergence degree.

In some embodiments, the processor may obtain the corrected candidate image according to a first preset relationship and the pixel value estimation of each of the at least a portion of pixels in the candidate image. The first preset relationship may include a correspondence between different pixel values and reference manners of updating pixel values. The reference manners of updating the pixel value may include, but is not limited to, multiplying a pixel value by a preset value, decreasing the pixel value by a preset value, updating the pixel value using a non-linear function, etc.

Taking the region A in the candidate image a as an example, assuming that in the first preset relationship, a pixel value in a pixel value range A corresponds to a manner A, and a pixel value in a pixel value range B corresponds to a manner B, if a pixel value in the region A in the candidate image a is in the range B, then the processor may use the manner B to update the pixel value in the region A in the candidate image a. In some embodiments, the first preset relationship may be preset by a technician based on experience.

In some embodiments, after the processor updates pixel values in all regions in the candidate image, the corrected candidate image is obtained. For example, after updating the pixel values in each region in the candidate image a, the processor obtains the corrected candidate image, denoted as a candidate image b.

In some embodiments, the processor may perform an activity reconstruction on the corrected candidate image to determine the initial image for the next iteration. In some embodiments, the processor may designate the corrected candidate image as a target image, or may continue to iteratively reconstruct the corrected candidate image to obtain the target image.

Merely by way of example, the processor may perform an activity reconstruction on the corrected candidate image a to obtain the candidate image b. Then, the processor may designate the candidate image b as the target image, or may use the candidate image b as the initial image in the next iteration.

In some embodiments of the present disclosure, an emission tomography dataset may be acquired, and an iterative reconstruction process may be performed on the emission tomography dataset to obtain the target image. In at least one iteration, a candidate image before a current iteration is performed may be acquired as the initial image in the current iteration, the initial image in the current iteration is segmented to obtain a plurality of regions, and at least one region in the a plurality of regions is inputted into the first trained machine learning model to obtain a pixel value estimation of at least one region. Then, a pixel value of each of the at least a portion of pixels in the initial image is updated based on the pixel value estimation to obtain a corrected candidate image, and an activity reconstruction is performed based on the corrected candidate image to obtain a candidate image for the current iteration. Moreover, each region corresponds to a different anatomical structure or a region of interest, and the candidate image is obtained through an initial iteration or a plurality of iterations of the emission tomography dataset. This can accelerate a convergence speed of a region, improve an accuracy of the region. Furthermore, the candidate image for the current iteration is more conducive to convergence, and the target image can be obtained with a faster convergence speed, improving a speed of obtaining the target image.

In some embodiments of the present disclosure, adjusting the pixel value of each of at least a portion of the pixels in the candidate image based on the estimation value corresponding to at least one pixel can break through a limitation of a global update of a traditional iterative algorithm, enabling a targeted and precise optimization of a key region (such as a lesion) or an under-converged region in an image. This can effectively suppress an overall image noise while significantly improving a contrast and a quantitative accuracy of a local region, generating a high-quality image that better meets a clinical diagnostic need.

In some embodiments of the present disclosure, by introducing a trained machine learning model for an intelligent intervention during the iterative reconstruction process, it is possible to targetedly accelerate a convergence speed of a different region in an image, which greatly shortens the time required to obtain an image with a high quantitative accuracy and improves the reconstruction efficiency. Secondly, it is possible to overcome a problem of a low quantitative image value caused by a low number of conventional iterations. Without increasing noise, it is possible to obtain a lesion parameter closer to its true value, significantly improving the accuracy and reliability of a quantitative diagnosis. Ultimately, a better balance between a reconstruction speed and an image quality is achieved.

In some embodiments, the predicted result may include the convergence degree corresponding to the at least one region in the candidate image. Generating a target image based on the predicted result and the candidate image includes: in response to determining that the convergence degree corresponding to each of the at least one region in the candidate image satisfies a first condition, terminating the iterative reconstruction process and designating the candidate image as the target image, the target image is a reconstructed image after the image reconstruction process; and in response to determining that the convergence degree corresponding to at least one of the at least one region in the candidate image does not satisfy the first condition, adjusting pixel values in the at least one of the at least one region in the candidate image to generate an updated candidate image according to the convergence degree corresponding to the at least one of the at least one region in the candidate image, the updated candidate image is designated as an initial image used in the next iteration. For more description of this embodiment, reference may be made to FIG. 6 and its related description.

FIG. 6 is a schematic diagram illustrating an exemplary process of generating a target image of a subject based on a convergence degree according to some embodiments of the present disclosure. In some embodiments, a process 600 may be performed by a processor. As shown in FIG. 6, the process 600 may include operations 610-620.

In 610, in response to determining that a convergence degree corresponding to each of the at least one region in the candidate image satisfies the first condition, the candidate image may be designated as a target image.

The first condition refers to a condition for determining whether an iteration has converged based on a convergence degree of a region.

In some embodiments, the first condition may be that the convergence degree of the region is within a convergence degree range or the convergence degree of the region is greater than or equal to the convergence degree threshold.

It may be understood that a size and a position of a region do not change during an iterative reconstruction process, and each region has a corresponding convergence degree threshold. For example, a region A corresponds to a convergence degree threshold A, a region B corresponds to a convergence degree threshold B, and so on. Optionally, the convergence degree threshold may include, but is not limited to, a mean of a standardized uptake value, i.e., SUVmean.

Then, after a processor determines a candidate image, the processor may determine the convergence degree of each region in the candidate image, thereby determining a count of regions whose convergence degree has reached a corresponding convergence degree threshold. If the convergence degrees of a preset count of regions in the candidate image(s) all reach their corresponding convergence thresholds, the processor determines that the candidate image satisfies a set condition. The preset count may be determined according to a need, and the preset count is less than or equal to a total count of all regions.

It should be noted that a convergence degree of a region reaching a corresponding convergence degree threshold may mean that the convergence degree of the region is equal to the corresponding convergence degree threshold, or a difference between the convergence degree of the region and the corresponding convergence degree threshold is less than a preset difference. The preset difference may be set according to a need, for example, a number close to 0.

In some embodiments, the first condition may be that a difference between a pixel value estimation corresponding to at least one pixel in the candidate image and at least one pixel value in the candidate image is less than or equal to a difference threshold.

The convergence degree range refers to a numerical range of a convergence degree that characterizes the convergence of the candidate image. For example, the convergence degree range may be [95%, 105%].

The difference threshold refers to a threshold condition between a pixel value and a pixel value estimation for considering the candidate image to have converged. For example, the difference threshold may be 5.

In some embodiments, the convergence degree range and the difference threshold may be preset by a technician based on experience.

For more content on how to determine the estimation value of a pixel, reference may be made to a related description below.

In 620, in response to determining that a convergence degree corresponding to at least one of the at least one region in the candidate image does not satisfy the first condition, adjust pixel values in the at least one of the at least one region in the candidate image according to the convergence degree corresponding to the at least one region in the candidate image to determine an initial image for a next iteration.

In some embodiments, in response to determining that the convergence degree corresponding to the one of the at least one region in the candidate image does not satisfy the first condition, a processor may adjust the pixel values in the one of the at least one region in the candidate image based on the convergence degree corresponding to the one of the at least one region of the candidate image.

For example, if the convergence degree is a ratio between the candidate image and a benchmark image, when a convergence degree corresponding to a region A is less than 1, the processor may increase a pixel value of each pixel in the region A based on a first preset value; when the convergence degree corresponding to the region A is greater than 1, the processor may decrease the pixel value of each pixel in the region A based on a second preset value.

As another example, if the convergence degree is a difference between the candidate image and the benchmark image, when a convergence degree corresponding to a region A is negative, the processor may increase a pixel value of each pixel in the region A; when the convergence degree corresponding to the region A is positive, the processor may decrease the pixel value of each pixel in the region A.

In some embodiments, the first preset value and the second preset value may be preset by a technician based on experience.

In some embodiments of the present disclosure, since it is possible to determine whether a candidate image satisfies a first condition, and in response to the candidate image satisfying a set first condition, the candidate image is designated as a target image; and in response to the candidate image not satisfying a set condition, a next iterative reconstruction is performed. Therefore, by determining whether the first condition is satisfied, a target image that satisfies the requirement can be obtained efficiently and accurately.

In some embodiments, the processor may determine an adjustment amplitude for adjusting the pixel values in the at least one of the at least one region of the candidate image based on the convergence degree corresponding to the at least one of the at least one region in the candidate image; and adjust the pixel values in the at least one of the at least one region in the candidate image based on the adjustment amplitude.

The adjustment amplitude refers to a parameter for adjusting the pixel values. The adjustment amplitude may be a ratio or a numerical value for adjusting the pixel values.

In some embodiments, the convergence degree is a ratio between the candidate image and the benchmark image, if the convergence degree corresponding to the one of the at least one region is less than 1, the adjustment amplitude is negatively correlated with the convergence degree; if the convergence degree corresponding to the one of the at least one region is greater than 1, the adjustment amplitude is positively correlated with the convergence degree.

In some embodiments, the convergence degree is a difference between the candidate image and the benchmark image, if the convergence degree corresponding to the one of the at least one region is higher than 0, the adjustment amplitude is positively correlated with the convergence degree; if a convergence degree corresponding to at least one region is less than 0, the adjustment amplitude is negatively correlated with the convergence degree.

In some embodiments, a processor may determine a ratio coefficient based on a quotient of a convergence degree threshold of a region and a convergence degree of the region. In some embodiments, the processor may determine the ratio coefficient based on a quotient of a convergence degree of the region and the convergence degree threshold of the region. Continuing with the region A in the candidate image a as an example, if a convergence degree for the region A in the candidate image a is 25%, and a convergence degree threshold for the region A is 100%, then the processor may use 100%/25%=4 as the ratio coefficient.

Further, the processor may update the pixel values in the region based on a product of the ratio coefficient and the pixel values in the region to obtain a corrected candidate image. Continuing the above example, the processor may multiply all pixel values in the region A in the candidate image a by 4 to update the pixel values in the region A. Different regions may correspond to different ratio coefficients.

It should be noted that the processor may update only a region whose pixel value does not satisfy a threshold, or may update all regions; the embodiment does not impose a limit. In some embodiments, the processor may obtain the corrected candidate image after updating the pixel values in all regions.

In some embodiments, the processor performs an activity reconstruction based on the corrected candidate image. For more content on the activity reconstruction, reference may be made to FIG. 5 and its related description.

In some embodiments, the processor may use a sum of the adjustment amplitude and a pixel value of each pixel in a region in the candidate image as a pixel value of the each pixel in an adjusted candidate image.

In some embodiments of the present disclosure, determining an adjustment amplitude for adjusting the pixel values in the one of the at least one region of the candidate image based on the convergence degree corresponding to the one of the at least one region in the candidate image, and then adjusting the pixel values in the one of the at least one region in the candidate image based on the adjustment amplitude, can efficiently allocate a computing power, perform a focused and rapid correction on a slowly converging region, while avoiding wasting a computing resource on an already converged region, thereby achieving an acceleration of an iterative reconstruction process and shortening a reconstruction time while ensuring a quality.

In the above image reconstruction method, it is possible to obtain the image data and perform an iterative reconstruction process on the image data to obtain the target image. During the iterative reconstruction process, in at least one iteration, a candidate image before a current iteration is performed may be acquired as the initial image in the current iteration, the initial image in the current iteration is segmented to obtain a plurality of regions. At least one region in the plurality of regions may be inputted into the first trained machine learning model to obtain a convergence degree corresponding to each of the at least one region. In response to a pixel value in the at least one region not satisfying a pixel threshold, the pixel value in the at least one region may be updated based on the convergence degree to obtain a corrected candidate image, and an activity reconstruction process may be performed based on the corrected candidate image to obtain the a candidate image in the current iteration. Furthermore, the candidate image is obtained through an initial iteration or a plurality of iterations based on the image data; each region corresponds to a different anatomical structure or a region of interest. In this way, by assigning a pixel value to a different region, a convergence speed of a region can be accelerated, and an accuracy of the region can be improved. Further, a candidate image generated after at least one iteration is more conducive to convergence, so the target image can be obtained with a faster convergence speed, improving a speed of obtaining the target image.

In some embodiments, a predicted result includes a confidence interval of a convergence degree corresponding to each of at least one region in the candidate image. The processor may, in response to determining that the confidence interval of the convergence degree corresponding to each of the at least one region in the candidate image satisfies a second condition, terminate the iterative reconstruction process and designate the candidate image as the target image; in response to determining that the confidence interval of the convergence degree corresponding to one of the at least one region in the candidate image does not satisfy the second condition, the processor may perform a next iteration of the at least one iteration and designate candidate image as an initial image used in the next iteration.

For example, FIG. 7 is a schematic diagram illustrating an exemplary process of generating a target image of a subject based on a confidence interval of a convergence degree according to some embodiments of the present disclosure. As shown in FIG. 7, a process 700 may be performed by the processor. The process 700 may include operations 710-720.

In 710, in response to determining that the confidence interval of the convergence degree corresponding to each of the at least one region in the candidate image generated in an iteration satisfies the second condition, the iterative reconstruction process may be terminated and the candidate image may be designated as the target image.

The confidence interval of a convergence degree corresponding to a region in the candidate image refers to a range between a highest convergence degree of a pixel value and a lowest convergence degree of a pixel within the region. The confidence interval of the convergence degree may represent an allowable fluctuation range of the convergence degree. When the convergence degree corresponding to the region in the candidate image falls within the confidence interval, the region is considered not converged; when the convergence degree corresponding to the region does not fall within the confidence interval, the region is considered converged.

In some embodiments, the processor may determine the confidence interval of the convergence degree based on the candidate image by first training the machine learning model. That is, the predicted result output by the first trained machine learning model may include the confidence interval of the convergence degree. For example, the processor may input at least one region in the candidate image into the first trained machine learning model, and the first trained machine learning model may perform a feature extraction based on the at least one region in the candidate image to output the confidence interval of the convergence degree of each of the at least one region in the candidate image.

The second condition refers to a condition for determining whether an iteration has converged based on the confidence interval of the convergence degree.

For example, the second condition may include that the confidence interval of the convergence degree of a region in the candidate image is a subset of a reference interval or within the reference interval. When the confidence interval of the convergence degree of each of the at least one region is a subset of the reference interval, the second condition is satisfied. The reference interval may be [95%, 105%]. The reference interval may be preset by a technician based on experience.

In some embodiments, the second condition may be preset by a technician based on experience.

In some embodiments, in response to determining that the confidence interval of the convergence degree corresponding to each of the at least one region in the candidate image satisfies the second condition, the iterative reconstruction process may be terminated and the candidate image generated in the current iteration may be designated as the target image.

In 720, in response to determining that the confidence interval of the convergence degree corresponding to at least one of the at least one region in the candidate image does not satisfy the second condition, a next iteration may be performed, and the candidate image may be designated as an initial image used in the next iteration.

It should be noted that in this embodiment, no pixel value adjustment is made to the candidate image, and the candidate image is directly designated as the initial image in the next iteration.

In some embodiments of the present disclosure, determining whether a candidate image has converged based on the second condition can prevent making an incorrect termination or a pixel adjustment decision in a case where a predicted result of a neural network is unreliable or has low confidence. This avoids outputting an image with a potential error as a final result, thereby significantly improving a robustness of the entire method in a complex real-world scenario and a credibility of an output image.

It should be noted that the above descriptions of the processes 500-700 are for example and illustration only, and do not limit an applicable scope of the present disclosure. For a person skilled in the art, various modifications and changes may be made to the processes 500-700 under the guidance of the present disclosure. However, these modifications and changes are still within the scope of the present disclosure.

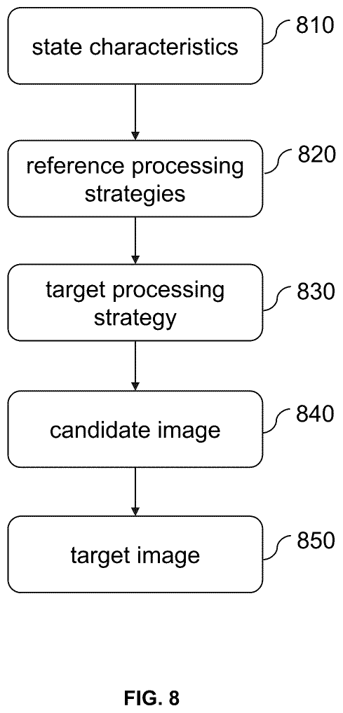

FIG. 8 is a schematic diagram illustrating an exemplary diagram of determining a target image of a subject according to some embodiments of the present disclosure.

In some embodiments, as shown in FIG. 8, when a predicted result includes the convergence degree corresponding to each of at least one region in the candidate image, the pixel value estimation of each of at least one pixel in the candidate image, or the confidence interval of the convergence degree corresponding to each of the at least one region in the candidate image, the processor may determine one or more state characteristics 810 of a candidate image 840. Based on the one or more state characteristics 810, the processor may determine a target processing strategy 830 from a plurality of reference processing strategies 820; and process the candidate image 840 using the target processing strategy 830 to generate a target image 850.

The state characteristics refer to a parameter used to quantify the information complexity and the pixel distribution dispersion of each of an overall candidate image and a lesion region. In some embodiments, the state characteristics may include a global image entropy or a lesion heterogeneity value.

The global image entropy refers to a parameter used to measure the uncertainty or the degree of chaos of the overall information content of an image.

In some embodiments, the processor may determine the global image entropy through various manners.

For example, the processor may count all pixels of a candidate image (or determine for each region separately) to obtain a count of pixels falling into each gray level i, denoted as ni; and determine a probability p(i) of each gray level appearing. If a total count of pixels in the candidate image (or each region of the candidate image) is N, then the p(i) is a ratio of ni to N. By applying a Shannon entropy formula, the probabilities p(i) for all gray levels are determined d and summed to obtain the global image entropy.

The lesion heterogeneity value refers to a parameter describing the variation and complexity of pixel values within a lesion region.

In some embodiments, the processor may determine the lesion heterogeneity value in various manners.

For example, the processor may determine a standard deviation σ of all pixel values within the lesion region in the candidate image and determine the lesion heterogeneity value based on the standard deviation σ of all pixel values within the lesion region in the candidate image. The high standard deviation σ value implies a high heterogeneity value. The standard deviation of pixel values is positively correlated with the lesion heterogeneity value, or the lesion heterogeneity value is equal to the standard deviation of the pixel values.

In some embodiments, the processor may combine the global image entropy and the lesion heterogeneity value into a set, and the set is determined as the state characteristics.

The reference processing strategy refers to a strategy for iteratively reconstructing the reconstructed image.

For example, the reference processing strategy may be to adjust pixel values in the candidate image and determine a target image based on an estimation value of pixels in at least one region.

As another example, the reference processing strategy may also be to determine a target image based on a convergence degree of at least one region in the candidate image.

As yet another example, the reference processing strategy may also be to determine a target image based on a confidence interval of a convergence degree of at least one region.

In some embodiments, the reference processing strategy may be preset by a technician by default in the candidate image.

The target processing strategy refers to a strategy finally selected for performing an iterative reconstruction process.

In some embodiments, the processor may determine the target processing strategy based on the first condition, the second condition, the first threshold, and the second threshold.

For example, when the global image entropy is less than the first threshold, and the lesion heterogeneity value is less than the second threshold, the target processing strategy may be to adjust pixel values and determine the target image based on the pixel value estimation of pixels in at least one region.

As another example, when the global image entropy is less than the first threshold, and the lesion heterogeneity value is greater than or equal to the second threshold, whether a confidence interval of a convergence degree corresponding to at least one region satisfies the second condition may be determine. If the second condition is satisfied, the candidate image may be designated as the reconstructed image; if the second condition is not satisfied, the candidate image is adjusted, and an adjusted candidate image is used as an initial image for the next iteration.

As yet another example, when the global image entropy is greater than the first threshold, whether the convergence degree corresponding to each of at least one region satisfies the first condition may be determined. If the first condition is satisfied, a candidate image is designated as a reconstructed image; if the first condition is not satisfied, the candidate image is adjusted, and an adjusted candidate image is used as an initial image for the next iteration.

In some embodiments of the present disclosure, determining a target processing strategy from a plurality of reference processing strategies based on one or more state characteristics, and processing a candidate image using the target processing strategy to generate a target image, eliminates a need for manually setting a uniform number of iterations or a filtering parameter. The system automatically decides to “continue iteration/stop/post-process” based on a real-time state characteristic, which can significantly reduce an invalid iteration, extend an iteration for a high-entropy or high-heterogeneity region, and terminate early for a low-entropy, low-heterogeneity region, thereby improving an efficiency.

FIG. 9 is a schematic diagram illustrating an exemplary diagram of a first trained machine learning model according to some embodiments of the present disclosure.

The first trained machine learning model refers to a model used to determine a predicted result. In some embodiments, the first trained machine learning model may be a machine learning model. For example, the first trained machine learning model may include, but is not limited to, at least one of a Convolutional Neural Networks (CNN) model, a Recurrent Neural Network (RNN) model, a Fully Convolutional Neural Network (FCN) model, a Generative Adversarial Network (GAN) model, a Back-propagation (BP) machine learning model, a Radial Basis Function (RBF) model, a Deep Belief Networks (DBN) model, an Elman model, or a combination model thereof.

In some embodiments, as shown in FIG. 9, an input of a first trained machine learning model 980 may include a candidate image 910, and an output may include a predicted result 990.

In some embodiments, the processor may input the candidate image into the first trained machine learning model, and output the convergence degree of the candidate image through the first trained machine learning model.

In some embodiments, the processor may acquire an iteration image sample and a convergence degree label corresponding to the iteration image sample, and the first trained machine learning model may be obtained by training based on the iteration image sample and the convergence degree label corresponding to the iteration image sample. The first trained machine learning model trained in this way is capable of processing the candidate image to obtain the convergence degree corresponding to the candidate image.

An iteration image sample is an iteration image of a different convergence degree. For example, the processor may collect a large count of fully converged images generated by a first count of iterations and not fully converged images generated by a second count of iterations as iteration image samples. The first count may exceed the second count. The convergence degree label is a pixel value when the iteration image sample is in a converged state. The processor may determine the convergence degree label corresponding to the iteration image sample in response to an input of user, or may determine the convergence degree label corresponding to the iteration image sample based on a pixel value of each pixel point in a candidate image.

Taking the candidate image a as an example, the processor may input the region A in the candidate image a into the first trained machine learning model to obtain the estimation value of pixels in the region A in the candidate image a.

In some embodiments, the processor may input a first feature data of the candidate image into the first trained machine learning model and output the convergence degree of the candidate image through the first trained machine learning model.

In some embodiments, the first feature data may include an image feature and an information feature of the candidate image.

In some embodiments, the processor may acquire image information of the candidate image; and encode the image information of the candidate image to obtain the first feature data. The processor may acquire the image information such as a reconstruction algorithm type, a count of iterations, a count of subsets, a filtering parameter, and a regularization parameter of the candidate image, and perform an encoding such as an embedding on the image information to obtain a corresponding feature vector, which serves as the first feature data. In this implementation, only a feature of the image information (i.e., the first feature data, also referred to as image information feature) is input into the first trained machine learning model. The first trained machine learning model performs a comparison and a calculation based on the input image information feature and outputs the convergence degree of the candidate image, and may also output a confidence interval of the convergence degree at the same time.

In some embodiments, the processor may acquire the image information of the candidate image; encode the image information of the candidate image to obtain a first feature vector; extract the image feature of the candidate image to obtain a second feature vector; and fuse the first feature vector with the second feature vector to obtain the first feature data.

On one hand, the image information of the candidate image is encoded by an embedding or the like to obtain a corresponding feature vector, denoted as the first feature vector; on the other hand, the image feature of the candidate image is extracted, which may be, for example, an image feature of a region of interest (e.g., a lesion region) contained in the candidate image, such as a lesion contour, a size, etc., to obtain the second feature vector. Then, the first feature vector is fused with the second feature vector. The fusion here may adopt a vector multiplication, a vector addition, or a vector weighted summation, and a result after a vector fusion serves as the first feature data. In this implementation, the input of the first trained machine learning model is a fused feature including the image information feature and the image feature. The first trained machine learning model performs a comparison and a calculation based on the input fused feature and outputs a convergence degree of the candidate image, and may also output a confidence interval of the convergence degree at the same time.

In some embodiments, a training process of the first trained machine learning model may include: acquiring a one-to-one corresponding sample image and benchmark image, the sample image and the benchmark image are generated using a same iterative reconstruction algorithm, a count of iterations of the benchmark image is higher than a count of iterations of the sample image, and the benchmark image corresponds to a highest convergence degree. The training process of the first trained machine learning model may also include constructing a training set data and a loss function based on the sample image and the benchmark image and obtaining the first trained machine learning model by training based on the training set data via minimizing the loss function. When constructing the training set data, it is necessary to acquire a one-to-one corresponding sample image and benchmark image. A count of sample images and a count of benchmark images acquired here are both multiple. The sample image and the benchmark image are generated using a same iterative reconstruction algorithm, the count of iterations of the benchmark image is higher than the count of iterations of the sample image, and the benchmark image corresponds to a highest convergence degree. In an actual operation, a sufficient amount of image data may be collected. For each image data, an image reconstruction algorithm (such as an MLEM algorithm) is used to reconstruct a sample image with a small count of iterations, and the same image reconstruction algorithm is used to reconstruct a benchmark image with a large count of iterations (e.g., >50 times). In this way, a plurality of one-to-one corresponding sample images and benchmark image images is obtained. Since the count of iterations of the benchmark image is high (e.g., >50 times), a mean of pixel values or each pixel value in at least one region of the benchmark image may be considered to have completely converged to a corresponding true image, so its convergence degree may be defined as the highest value (e.g., 100%). As an example, the sample image may be an image reconstructed using a clinical protocol, for example, an image reconstructed using an OSEM algorithm (20 subsets, 2 iterations); the benchmark image may be an image reconstructed with a plurality of iterations, for example, an image reconstructed using the OSEM algorithm (20 subsets, 50 iterations). After obtaining a sufficient count of sample images and benchmark images, the training set data and a loss function for a model training may be constructed based on the sample images and benchmark images. Then, based on the training set data and by minimizing the loss function, the first trained machine learning model is trained and obtained.

In some embodiments, the processor may construct the training set data based on the sample image and the benchmark image. For example, the processor may generate second feature data of the sample image based on a image information and an image feature of the sample image; generate third feature data of the benchmark image based on image information and an image feature of the benchmark image; and construct the training set data with the second feature data as an input and a difference between the second feature data and the third feature data as an output target (i.e., a label).

Specifically, when constructing the training set data based on the sample image and the benchmark image, feature data of the sample image and a feature data of the benchmark image are extracted respectively. The feature data of the sample image is denoted as second feature data, and the feature data of the benchmark image is denoted as third feature data. When generating the feature data, image information and an image feature of a corresponding image (i.e., the sample image or the benchmark image) may be combined, that is, the second feature data is generated based on the image information and the image feature of the sample image, and the third feature data is generated based on the image information and the image feature of the benchmark image. The image information here may be the reconstruction algorithm type, the count of iterations, the count of subsets, the filtering parameter, the regularization parameter, etc., used for the image, and the image feature may be a pixel value at various positions in the image. In an actual operation, each of the image information and the image feature may be converted into a corresponding feature vector, and then the two feature vectors are fused to obtain the corresponding feature data. Finally, with the second feature data as an input and a difference between the second feature data and the third feature data as an output target, the training set data is constructed. The difference between the second feature data and the third feature data may be defined as a convergence degree of the sample image, specifically a feature ratio between a partial region (e.g., a lesion region) of the sample image and a corresponding region in the benchmark image. For example, the difference between the second feature data and the third feature data may be may be an average of ratios of pixel values at various positions within a region, a ratio of an average pixel value within the region, a ratio of a maximum pixel value within the region, or a ratio of a minimum pixel value within the region, etc. The feature ratio may be represented by k. When k=100%, it indicates the convergence degree of the sample image is 100%; when k=70%, it indicates the convergence degree of the sample image is 70%, etc.

In some embodiments, the processor may generate the second feature data of the sample image based on the image information and the image feature of the sample image.

For example, the processor may perform a region segmentation processing on a sample image to obtain a first region of interest of the sample image; extract the image feature of the first region of interest and adjacent regions of the first region to obtain a third feature vector; encode the image information of the sample image to obtain a fourth feature vector; and fuse the third feature vector and the fourth feature vector to obtain the second feature data.

Generating the third feature data of a benchmark image based on the image information and the image feature of the benchmark image includes: performing a region segmentation processing on the benchmark image to obtain a second region of interest of the reference image; extracting an image feature of the second region of interest and adjacent regions of the second region of interest to obtain a fifth feature vector; encoding the image information of the benchmark image to obtain a sixth feature vector; and fusing the fifth feature vector and the sixth feature vector to obtain the third feature data.

It should be understood that a user is only concerned with a partial region of an image, not the entire image. To reduce the computational amount of feature data processing, a region segmentation processing may be performed on the image to obtain a region of interest. A region extracted after performing the region segmentation processing on the sample image is denoted as a first region of interest, and a region extracted after performing the region segmentation processing on a benchmark image is denoted as a second region of interest. The region of interest may be a lesion organ, and the size of the region of interest exceeds one pixel. At this time, extracting the region of interest may reduce the computational amount of the feature data processing. In a special case, the size of the region of interest is equal to one pixel at this time, the meaning of a region is not considered, and a deep learning network is equivalent to performing a point-to-point mapping processing, which has the same effect as not performing an image segmentation processing.

For example, for the image data, the processor may use a PET image, a CT image, and other anatomical information, and use a deep learning network such as a U-Net to extract and segment a lesion region as the region of interest. After segmenting the region of interest, an image feature of the region of interest and an image feature of an adjacent region of the region of interest are extracted to obtain a corresponding feature vector, and then the feature vectors are fused with a feature vector obtained after encoding image information to obtain corresponding feature data.

Specifically, for a sample image, a feature vector obtained by extracting an image feature of a first region of interest and an adjacent region of the first region of interest is denoted as the third feature vector. The image information of the sample image is encoded. For example, an embedding may be used to convert the image information into a low-dimensional vector, thereby obtaining a fourth feature vector. The third feature vector and the fourth feature vector are fused. The fusion here may use a vector multiplication, a vector addition, or a vector weighted summation. A result obtained after a vector fusion is used as the feature data of the sample image, i.e., the second feature data. For a benchmark image, a feature vector obtained by extracting an image feature of a second region of interest and an adjacent region of the second region of interest is denoted as the fifth feature vector. The image information of the benchmark image is encoded to obtain the sixth feature vector. The fifth feature vector and the sixth feature vector are fused, and the result obtained after a vector fusion is used as the feature data of the sample image, i.e., the third feature data. Finally, with the second feature data as an input and the difference between the second feature data and the third feature data as an output target, the training set data is constructed.

Assume the sample image is image data, and the benchmark image is a gold standard image that may be regarded as a true image. The gold standard image refers to a benchmark image that is used as an absolute reference benchmark.

For example, an input of the training set data is feature data of a lesion and an adjacent region of the lesion in the image data, and an output target is a ratio of the feature data of the lesion and the adjacent region of the lesion in the image data to a feature data of a lesion and the adjacent region of the lesion in a gold standard image. As another example, an input of the training set data is feature data of the image data, and an output target is a ratio of the feature data of the image data to the feature data of the gold standard image.

As an example, assuming a region of interest is a lesion region, a loss function constructed for the model training may include the following 3 types:
(A) a difference between an output result ‘output’ of a network at each iteration and an output target k at each pixel point.
(B) a difference between an output result ‘output’ of a network at each iteration and an output target k at each pixel point within the lesion region.
(C) a difference between an output result ‘output’ of a network at each iteration and an output target k in terms of an average pixel value within the lesion region.

The constructed loss function may be any type of function, represented by Loss=F(k, output). Taking an L1 loss as an example, for a type (A), the loss function may be represented as:

$$F = \frac{1}{N} {\sum }_{j = 1}^{N} \vert {k}_{j} - f ( {x}_{j} ) \vert$$

For a type (B), the loss function may be represented as:

$$F = \frac{1}{{n}_{l}} {\sum }_{i = 1}^{{n}_{l}} {\sum }_{j = 1}^{n} \vert {k}_{i j} - f ( {x}_{i j} ) \vert$$

For a type (C), the loss function may be represented as:

$$F = \frac{1}{{n}_{l}} {\sum }_{i = 1}^{{n}_{l}} \vert {\sum }_{j}^{n} {k}_{i , j} / n - {\sum }_{j}^{n} f ( {x}_{i , j} ) / n \vert$$

N represents a count of pixel points in an image, nₗ represents a count of lesions, n represents a count of pixel points in a lesion region, i represents a lesion index, j represents a pixel point index, and k represents a feature ratio between a sample image and a benchmark image.

After constructing the loss function, based on training set data and by minimizing the loss function, model parameters of a machine learning model are continuously iterated and optimized, and finally a first trained machine learning model is obtained with optimized model parameters.

In some embodiments, after training and obtaining the first trained machine learning model, the processor may acquire a plurality of test images from the sample images; input the plurality of test images into the first trained machine learning model, and output a predicted result of each of the plurality of test images through the first trained machine learning model; and determine a confidence interval of a convergence degree of the predicted result output by the first trained machine learning model based on the fourth feature data of each of the plurality of test images, the fifth feature data of a benchmark image corresponding to the each of the plurality of test images, and the predicted result of each of the plurality of test images.

In some embodiments, the processor may acquire the plurality of test images from the sample images as test set data, input the plurality of test images into the first trained machine learning model for processing, output a predicted result of each of the plurality of test images through the first trained machine learning model, and determine a confidence interval of a convergence degree of the model predicted result by manners of an image feature data comparison. Specifically, the feature data of each of the plurality of test images is acquired, denoted as the fourth feature data, and feature data of a benchmark image corresponding to each of the plurality of test images is acquired, denoted as the fifth feature data. An index parameter of a region of interest in the test image is determined based on the fourth feature data, such as an average pixel value, a maximum pixel value, a minimum pixel value, a pixel value at each position point within a lesion region, etc.

It should be understood that the same index parameter of the region of interest in the benchmark image may be determined based on the fifth feature data. By comparing the index parameter of the region of interest in the benchmark image and the index parameter of the region of interest in the test image, a confidence interval of a convergence degree for convergence degree prediction with a certain confidence level (e.g., 95%) may be obtained. In addition, the test images may be classified according to a lesion type, and test images of the same lesion type are acquired to determine the confidence interval of the convergence degree for the current lesion type.

For example, 100 liver lesion images may be acquired as test images, and the test images are input into the first trained machine learning model for processing to obtain 100 predicted results. Based on the 100 predicted results, a sample statistic is performed to determine the confidence interval of the convergence degree corresponding to the liver lesion images.

For example, when a model training process starts, a large amount of raw data that has not undergone an iterative reconstruction operation, i.e., image data, is acquired. The same image reconstruction algorithm is used to perform an image reconstruction process with different counts of iterations on the image data respectively. A gold standard image may be generated via the image reconstruction process with a high count of iterations generates, and a sample image may be generated via an image reconstruction process with a low count of iterations. Multiple sample images may be generated. Then, the image information of the sample image and the gold standard image is read and encoded, and an image region segmentation is performed on each of at least a portion of the sample images and the gold standard image to obtain a lesion region. The training set data is constructed based on the feature data of the lesion region and an adjacent region of the lesion region, and a loss function is constructed. Next, based on the training set data and by minimizing the loss function, the machine learning model is trained, and model parameters of the machine learning model are continuously optimized. In addition, sample images may be selected for test (also referred to as test images), or an index parameter of the lesion region is determined from target images corresponding to the sample images to be predicted. The index parameter may include a lesion size, pixel values in a lesion region, etc. By performing a sample statistic on predicted results of the sample images, a confidence interval of a convergence degree of the predicted results may be determined to determine the accuracy of the trained machine learning model.

In some embodiments of the present disclosure, by pre-training a deep learning model for predicting a convergence degree of the image reconstruction as a first trained machine learning model, after obtaining a reconstructed image generated by an iterative reconstruction process, it is only necessary to input the feature data of the reconstructed image into the first trained machine learning model for processing. The first trained machine learning model may then output the convergence degree of the reconstructed image, which is used to represent a feature difference between the reconstructed image and a corresponding target image. Since the first trained machine learning model outputs a quantitative numerical predicted result, a quantitative calculation of the convergence degree of the image reconstruction is realized.

In some embodiments, the processor may input a candidate image (or a candidate image divided into at least one region) into the first trained machine learning model and output the convergence degree corresponding to each of at least one region in the candidate image through the first trained machine learning model.

In some embodiments, the processor may identify one or more lesions in the candidate image, determine the area containing each lesion as a lesion region, and input each lesion region into the first trained machine learning model. The first trained machine learning model then outputs the convergence degree corresponding to each input lesion region.

In some embodiments, the processor may input the candidate image into the first trained machine learning model and output the pixel value estimation of each of at least a portion of pixels in the candidate image through the first trained machine learning model.

In some embodiments, the first trained machine learning model may also be configured to perform a convergence degree prediction on pixel values in at least one region to obtain the convergence degree of the at least one region; and in response to the convergence degree of the at least one region not satisfying a convergence degree threshold, obtain the pixel value estimation of pixels in the at least one region.

It should be understood that after the processor inputs a region into a first trained machine learning model, the first trained machine learning model performs a convergence degree prediction based on pixel values in the region to obtain the convergence degree of the region, and when the convergence degree of the region does not satisfy the convergence degree threshold, outputs a pixel value estimation of pixels in the region. It should be noted that the convergence degree thresholds corresponding to different regions may be the same or different. The convergence degree may be a predicted Standardized Uptake Value (SUV) of the region.

Exemplarily, taking the region A in the candidate image a as an example, the processor inputs the region A into the first trained machine learning model. The first trained machine learning model obtains a convergence degree of the region A as 60% based on pixel values in the region A. Assuming a convergence degree threshold for the region A is 100%, the convergence degree prediction of the region A (i.e., 60%) has not satisfied the convergence degree threshold. In this case, the first trained machine learning model then outputs a pixel value estimation of pixels in the region A. Taking the region A in the candidate image a as an example, after inputting the region A into the first trained machine learning model, the convergence degree of the region A output by the first trained machine learning model is obtained. The convergence degree of the region may be from 0% to 100%. The convergence degree is 0% indicates completely uncovered, and the convergence degree is 100% indicates completely converged. The first trained machine learning model may be determined based on image samples (or sample images) and a convergence degree label of each region in each of the image samples.

Taking a Fluorodeoxyglucose (FDG) bone imaging as an example, after segmenting a bone region from a reconstructed image before a current iteration is performed, and inputting the bone region, a count of iterations for an iterative processing of the reconstructed image before the current iteration is performed, and a basic patient information corresponding to the bone region into the first trained machine learning model, the first trained machine learning model may output a convergence degree of the bone region.

In some embodiments, the processor may input a candidate image (or a candidate image divided into at least one region) into a first trained machine learning model and output a confidence interval of a convergence degree corresponding to each of at least one region in the candidate image through the first trained machine learning model.

In some embodiments, as shown in FIG. 9, an input of the first trained machine learning model 980 further comprises region segmentation information 920 of a candidate image 910. For example, when using the first trained machine learning model to determine a convergence degree corresponding to each of at least one region in the candidate image or a confidence interval of a convergence degree corresponding to each of the at least one region, the region segmentation information of the candidate image may be input into the first trained machine learning model.

The region segmentation information refers to information used to determine how a candidate image is divided. In some embodiments, the region segmentation information may include an identification indicating that at least a portion of pixels in the candidate image belongs to a target region in the at least one region.

In some embodiments, the region segmentation information may be preset by a processor by default.

In some embodiments, the first trained machine learning model may include a region segmentation layer. The region segmentation layer refers to a model used for segmenting a candidate image. In some embodiments, the region segmentation layer may be a machine learning model. For example, the region segmentation layer includes a convolutional neural network model (CNN), a recurrent neural network (RNN) model, etc., or a combination thereof.

In some embodiments, an input of the region segmentation layer may be a candidate image and the region segmentation information of the candidate image, and an output of the region segmentation layer may be at least one region in the candidate image.

In some embodiments, the region segmentation layer may be obtained through training with first training samples with first training labels. One of the first training sample may also include a sample candidate image and sample region segmentation information. The first training label corresponding to the first training sample is at least one region corresponding to the first training sample.

For example, the processor may perform a region segmentation processing on a sample candidate image and a benchmark image corresponding to the sample candidate image to obtain a one-to-one corresponding sample segmented image and benchmark segmented image. Different sample segmented images or different benchmark segmented images correspond to different anatomical structures or regions of interest. A sample segmented image and a benchmark segmented images corresponding to the sample segmented image may represent the same anatomical structure or region of interest. An initialized region segmentation layer is trained using the one-to-one corresponding sample segmented image and benchmark segmented image.

In some embodiments, a training manner for a region segmentation layer is similar to a training manner of the first trained machine learning model. For more content on training the first trained machine learning model, reference may be made to a related description above.

In some embodiments of the present disclosure, segmenting a candidate image based on the region segmentation information can fully reflect a role of the segmentation, which is beneficial to improving a model efficiency, allowing a first trained machine learning model to focus on predicting a predicted result.

In some embodiments, as shown in FIG. 9, an input of the first trained machine learning model 980 further comprises at least one of a type of reconstruction algorithm 930 of a candidate image, a count of iterations 940 for generating the candidate image, information of the subject 950, or a scanning protocol for the image data 960.

The reconstruction algorithm refers to an algorithm for performing an iterative reconstruction process on a candidate image.

For example, the reconstruction algorithm may include a Maximum-Likelihood Expectation Maximization (MLEM) algorithm, a Bayesian penalized likelihood (BPL) algorithm, an OSEM algorithm (Ordered Subset Expectation Maximization), etc.

In some embodiments, the reconstruction algorithm may be preset by a technician based on experience.

Information of the subject refers to basic information related to a subject. For example, the information of the subject may include a gender, an age, a height, a weight, etc.

In some embodiments, the processor may directly obtain the information of the subject from a storage device.

The scanning protocol refers to a set of parameters describing an acquisition process of the imaging device. For example, the scanning protocol may include a type of injected radiopharmaceutical (18F-FDG, 68Ga-PSMA, etc.), an injection dose, a waiting time from an injection to a start of a scan, a scan duration for each bed position, etc.

In some embodiments, the scanning protocol may be preset by a processor by default.

In some embodiments of the present disclosure, using at least one of a type of reconstruction algorithm of a candidate image, a count of iterations for generating the candidate image, information of a subject, or a scanning protocol for image data as an input to the first trained machine learning model can reduce a reconstruction error caused by a difference in a body type of the subject, a blood glucose level, a scan duration, etc., improve a generalization ability of a same network across different devices and different protocols, shorten a count of iterations required to reach a clinically acceptable convergence degree, and accelerate an overall reconstruction speed while reducing a radiation dose or a scan time.

In some embodiments, as shown in FIG. 9, the input of the first trained machine learning model 980 further comprises prior information 970. For example, the processor may also input the at least one region and the prior information together into the first trained machine learning model to obtain an estimation value of pixels in the at least one region.

In some embodiments, the prior information may be information related to a lesion in a subject, and determined based on a reference image of the subject. For example, the prior information may include, but is not limited to, an unconventional geometric information (e.g., a lesion location, a lesion size, a lesion shape, etc.), an advanced geometric information (e.g., a uniformity, a compactness, etc.), a topological information (e.g., a proximity relationship, a count of lesions, etc.), etc.

In some embodiments, the prior information may be information used to accelerate an output of the first trained machine learning model. The prior information may be information determined based on a candidate image before a current iteration is performed. For example, the prior information may include, but is not limited to, a medical history of the subject, personalized information of the subject, detector information, pixel value ranges of a lesion in different regions, a size, a shape, etc., of the lesion, etc. The count of iterations for an iterative reconstruction processing represents a count of times a candidate image has been iteratively updated before the current iteration is performed.

In some embodiments, the prior information includes patient information, scanning parameters, reconstruction parameters, and image processing parameters associated with the image data. The patient information refers to physiological and clinical data directly related to the subject. The patient information may include, but is not limited to, weight, height, body surface area, blood glucose level, age, gender, medical history reports, pathology reports associated with the subject, or the like, or a combination thereof. The scanning parameters may include radiopharmaceutical information (e.g., drug type, dosage, and time from injection to scan), scan duration, a scan mode, or the like. The reconstruction parameters may include the reconstruction algorithm type, the count of iterations, the point spread function (PSF), or the like. The image processing parameters may include parameters for operations such as preprocessing the image data. The image processing parameters may include a filter type and strength, regularization parameters, or the like.

In some embodiments, the prior information may be preset by a technician based on experience.

In some embodiments of the present disclosure, determining a predicted result based on the prior information can automatically correct a reconstruction deviation according to the prior information such as a BMI, blood glucose, and a lesion SUV range of a subject, which can significantly improve an accuracy of a quantification value of the SUV. The prior information acts as a “soft constraint”, enabling an iteration to approach a true solution in an early stage, thereby shortening the reconstruction time and reducing the radiation dose.

In some embodiments, the processor may input the reference image into a second trained machine learning model to determine the prior information.

The second trained machine learning model refers to a model used to determine the prior information. In some embodiments, the second trained machine learning model may be a machine learning model. For example, the second trained machine learning model includes, but is not limited to, one or a combination of a convolutional neural network model (CNN), a recurrent neural network model (RNN), etc.

In some embodiments, an input of the second trained machine learning model may include the reference image, and an output may include the prior information. The reference image may be data used for an iterative reconstruction process, or may be image data acquired by a medical device (e.g., a CT image).

In some embodiments, the second trained machine learning model may be obtained by training with second training samples having second training labels. A second training sample may include a sample reference image. The second training label corresponding to the second training samples is prior information corresponding to the second training sample.

The second training sample may be determined based on historical data. For example, the historical data may be historical image data from historical scan records. In some embodiments, the processor may designate a reconstructed image generated based on the historical image data via a lower count of iterations as a second training sample. For each of the second training samples, the processor may designate prior information of the second training sample, determined by a human, as the second training label corresponding to the second training sample.

In some embodiments, a training manner for the second trained machine learning model is similar to the training manner of the first trained machine learning model. For more content on training the first trained machine learning model, reference may be made to a related description below.

In some embodiments of the present disclosure, determining the prior information through a second trained machine learning model can enable a subsequent iterative reconstruction for a new subject to call upon the prior information under a zero or few sample condition, significantly reducing a count of iterations required to achieve a clinical convergence, while suppressing a noise amplification and an artifact generation, and shortening a scan/reconstruction time while improving a quantitative accuracy, thereby gaining an overall individualized, low-dose, high-fidelity image reconstruction.

In some embodiments, the first trained machine learning model may be obtained by training with first training samples with first training labels. Each of the first training samples may include a sample candidate image. The first training label corresponding to a first training sample includes at least one of a convergence degree, a pixel value estimation of each pixel, and a confidence interval of the convergence degree of a region in the first training sample. For example, the first training label may include a convergence degree, a confidence interval of the convergence degree, and an estimation value of each pixel corresponding to each region in the first training sample.

A first training sample may be determined based on historical data. For example, the historical data may be historical image data from a historical scan record. The first training sample may include a sample candidate image reconstructed based on the historical image data. In some embodiments, the processor may designate a reconstructed image generated based on the historical image data via a lower count of iterations as a first training sample. For the first training sample, the processor may designate a reconstructed image generated based on the historical image data via a higher count of iterations as a benchmark image. The processor may determine a convergence degree based on the first sample image and the benchmark image, and designate the convergence degree as a first training label corresponding to the first training sample.

For example, if a sample candidate image X includes a region A, a region B, and a region C, and a benchmark image includes a region A′, a region B′, and a region C′; the region A corresponds to the region A′, the region B corresponds to the region B′, and the region C corresponds to the region C′; a mean of all pixel values in the region A is denoted as a, and a mean of all pixel values in the region A′ is denoted as a′; a mean of all pixel values in the region B is denoted as b, and a mean of all pixel values in the region B′ is denoted as b′; a mean of all pixel values in the region C is denoted as c, and a mean of all pixel values in the region C′ is denoted as c′; a convergence degree m1 corresponding to the region A, a convergence degree m2 corresponding to the region B, and a convergence degree m3 corresponding to the region C are determined; the m1 may be a ratio or a difference of the means of pixel values in the region A and the region A′, and the m2 and m3 are similar. Designate m1, m2, and m3 as convergence degree labels corresponding to the sample candidate image X.

As another example, for the sample candidate image X, a pixel value of each pixel in a benchmark image corresponding to the sample image X is directly used as an pixel value estimation label of the pixel.

In some embodiments, the processor may perform a plurality of iterations to train an initial first trained machine learning model based on the first training samples with first training labels until an iteration termination condition is satisfied to obtain a trained first trained machine learning model. An iteration in the plurality of iterations includes: inputting a first training sample into the initial first trained machine learning model to obtain a model predicted output corresponding to the first training sample; substituting the model predicted output corresponding to the first training sample and the first training label corresponding to the first training samples into a formula of a predefined loss function to determine a value of the loss function; and updating a model parameter in the initial first trained machine learning model based on the value of the loss function. When the iteration termination condition is satisfied, the trained first trained machine learning model may be obtained. The iterative updating of the model parameters in the initial first trained machine learning model may be performed by various manners, for example, a gradient descent manner. The iteration termination condition may include a convergence of the loss function or a count of iterations reaching an iteration count threshold, etc. The iteration termination condition may be the convergence of the loss function, the count of iterations reaching a preset count threshold, or the value of the loss function being less than a preset function value threshold, etc.

In some embodiments, the first training label includes a reference confidence interval. The processor may classify the first training samples into a plurality of groups based on key features of the first training samples; and for each of the plurality of groups: determine a set of convergence degrees of first training samples in the group; determine statistical features of the set of convergence degrees; and determine the reference confidence interval based on the statistical features of the set of convergence degrees.

The reference confidence interval refers to a confidence interval of a convergence degree corresponding to each region of a benchmark image corresponding to a first sample image.

In some embodiments, the processor may determine the reference confidence interval based on the benchmark image.

The key features refer to features of a first training sample. For example, key features may include a lesion size (e.g., <1 cm, 1-3 cm, >3 cm), an organ where a lesion is located (e.g., the liver, the lung, a bone, the brain, etc.), a patient information (e.g., a height, a weight, a medical history, etc.).

In some embodiments, the processor may directly obtain the key features from a memory.

The sample group refers to first training samples grouped based on key features.

In some embodiments, the processor may treat the first training samples with a same key feature as one sample group.

The set of convergence degrees refers to a set of convergence degrees corresponding to a plurality of first training samples within a sample group.

In some embodiments, the processor may obtain the convergence degrees of the plurality of first training samples within a sample group and integrate the plurality of convergence degrees into one set of convergence degrees.

The statistical features refer to mathematical statistical features of a set of convergence degrees. For example, the statistical features may include a mean and a standard deviation of the set of convergence degrees.

In some embodiments, the processor may determine a reference confidence interval based on statistical features. For example, a range of the mean of the set of convergence degrees plus or minus three standard deviations may be determined as the reference confidence interval.

In some embodiments of the present disclosure, classifying first training samples into groups based on key features of the first training samples, then determining a set of convergence degrees for a sample group; determining statistical features of the set of convergence degrees; and determining a reference confidence interval for the sample group based on the statistical features, can achieve a complete automation and a standardization of a label generation process and can greatly reduce a manpower and a time cost for constructing a training set, making it possible to train a large-scale, high-precision confidence interval prediction model.

In some embodiments, the first training sample may also include sample region segmentation information.

In some embodiments, the first training sample may include at least one of a sample reconstruction algorithm, a sample iteration count, sample subject information, or sample scanning protocol information.

In some embodiments, the first training sample may further include sample prior information.

In some embodiments, the first trained machine learning model may be obtained by a training with the first training samples with first training labels. The set of first training samples may also include a sample prior information. The first training label corresponding to a first training sample is a predicted result corresponding to the first training sample.

In some embodiments, the input of the first trained machine learning model may also include medical history data of patient. The medical history data of patient may include a disease type, a disease duration, a treatment type, a treatment duration of a subject, etc.

In some embodiments, the medical history data of patient also includes a key text embedding data obtained from a historical pathology report of the subject. In some embodiments, the processor may obtain the key text embedding data in various ways. For example, the processor may extract a key descriptive text from the historical pathology report of the subject, such as “necrosis,” “poorly differentiated,” “nerve invasion,” “vascular tumor thrombus”; and use a trained word embedding model to convert the key descriptive text into a fixed-length feature vector that may capture a semantic information, and use the feature vector as the key text embedding data.

In some embodiments of the present disclosure, determining a predicted result based on the medical history data of patient can elevate a process from a simple “image pattern recognition” to an “image pattern recognition combined with a causal inference combined with a clinical history”, thereby improving an accuracy of the predicted result.

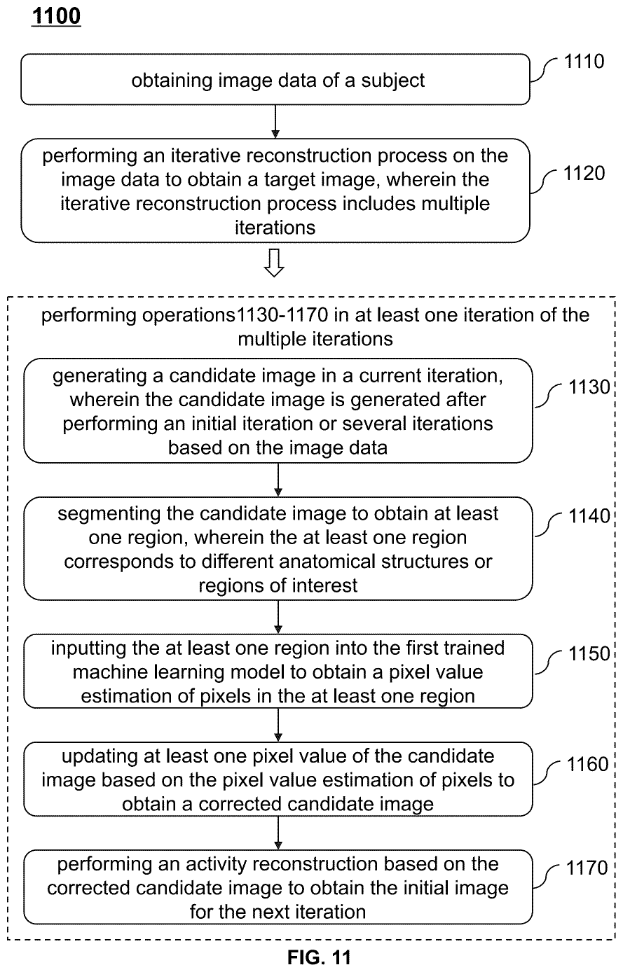

FIG. 11 is a schematic diagram illustrating an exemplary flowchart of an iterative reconstruction process according to some embodiments of the present disclosure. In some embodiments, as shown in FIG. 11, a process 1100 may be performed by the processor, and the process 1100 may include operations 1110-1170.

In 1110, image data of a subject may be obtained.

In 1120, an iterative reconstruction process may be performed on the image data to obtain a target image. The iterative reconstruction process may include multiple iterations and each of at least a portion of the multiple iterations may be performed according to operations 1130-1170.

In 1130, a candidate image may be generated in a current iteration, the candidate image is generated after performing an initial iteration or several iterations based on the image data.

In 1140, the candidate image is segmented to obtain at least one region, and the at least one region corresponds to different anatomical structures or regions of interest.

In 1150, the at least one region is input into the first trained machine learning model to obtain a pixel value estimation of pixels in the at least one region.

In 1160, at least one pixel value in the candidate image is updated based on the pixel value estimation of pixels to obtain a corrected candidate image.

In 1170, an activity reconstruction is performed based on the corrected candidate image to obtain an initial image for the next iteration.

For more description of operations 1110-1170, reference may be made to a further description in FIGS. 5-8.

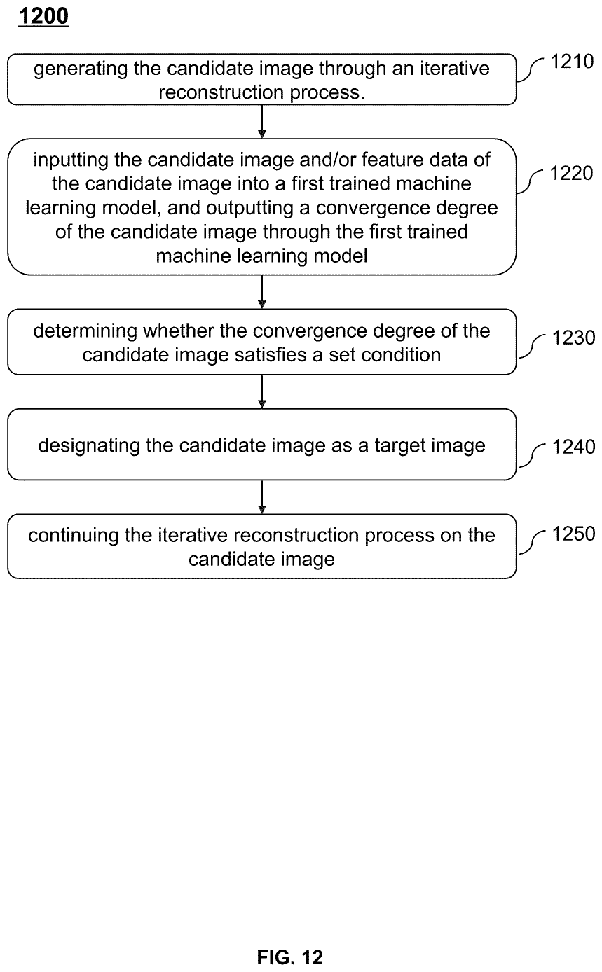

FIG. 12 is a schematic diagram illustrating an exemplary process for image reconstruction according to some embodiments of the present disclosure. In some embodiments, as shown in FIG. 12, a process 1200 may be performed by the processor, and the process 1200 may include operations 1210-1250.

In 1210, a candidate image may be generated through an iterative reconstruction process.

In 1220, the candidate image and/or feature data of the candidate image may be input into a first trained machine learning model, and a convergence degree of the candidate image may be output through the first trained machine learning model.

In 1230, whether a convergence degree of the candidate image satisfies a set condition may be determined.

In 1240, the candidate image is designated as the target image.

In 1250, continuing the iterative reconstruction process on the candidate image.

After obtaining the convergence degree of the candidate image, it is determined whether the convergence degree satisfies the set condition. If the convergence degree satisfies the set condition, operation 1240 is performed; if the convergence degree does not satisfy the set condition, operation 1250 is performed. For example, it may be determined whether a difference between the convergence degree and 100% is within ±5%. If the difference between the convergence degree and 100% is within ±5%, it indicates that a feature difference between the candidate image and a corresponding target image is less than 5%.

The set condition may be set according to a need. Optionally, the computer device may determine that the candidate image generated after the iterative reconstruction process has been performed M iterations satisfies the set condition. For example, after the iterative reconstruction process has been performed 3 iterations, the processor determines that the candidate image of the current iteration obtained in a third iteration satisfies the set condition.

In some embodiments, the computer device may also determine that the candidate image of the current iteration satisfies the set condition in response to determining that the convergence degrees of a predetermined count of regions in the candidate image of the current iteration all satisfy a corresponding convergence degree threshold.

It should be understood that a size and a position of a region do not change during an image iteration process, and each region has a corresponding convergence degree threshold. For example, a region A corresponds to a convergence degree threshold A, a region B corresponds to a convergence degree threshold B, and so on. Optionally, the convergence degree threshold may include, but is not limited to, a target mean of a standardized uptake value, i.e., SUVmean.

After the candidate image is generated in a current iteration, the processor may determine a convergence degree prediction for each region in the candidate image of the current iteration, thereby determining a count of regions whose convergence degrees have reached a corresponding convergence degree threshold. If the preset count of regions in the candidate image generated in the current iteration have their convergence degrees all reaching the corresponding convergence degree thresholds, the processor determines that the candidate image of the current iteration satisfies the set condition. The preset count may be determined according to a need, and the count number is less than or equal to a total count of all regions in the candidate image.

It should be noted that a convergence degree of a region reaching a corresponding convergence degree threshold may indicate that the convergence degree of the region is equal to the corresponding convergence degree threshold, or that a difference between the convergence degree of the region and the corresponding convergence degree threshold is less than a preset difference. The preset difference may be set according to a need.

In 1240, the candidate image may be designated as a target image.

In a case where the convergence degree satisfies the set condition, a feature difference between the candidate image and the corresponding target image is very small, and it is considered that the candidate image has achieved a good image reconstruction effect. Thus, the candidate image is designated as the completely reconstructed target image, and thereafter, the target image is output to provide assistance for a lesion diagnosis.

In 1250, the iterative reconstruction process is continued on the candidate image.

In a case where the convergence degree does not satisfy the set condition, a feature difference between the candidate image and the corresponding target image is large, which indicates that an image reconstruction effect of the candidate image is poor, and it is necessary to continue to perform an iterative reconstruction process on the candidate image to improve the convergence degree. After performing the iterative reconstruction process on the candidate image, the process returns to perform 1220, that is, the first trained machine learning model is used again to obtain the convergence degree of the candidate image, and it is continuously determined whether the convergence degree satisfies the set condition, until a candidate image with a convergence degree that satisfies the set condition and output as a target image

Through this setting, it is possible to use a machine learning model to detect a quantitative convergence degree value of an image in real-time during an image reconstruction process, continuously evaluating whether a current convergence degree of the image satisfies a condition, and finally, a target image with a convergence degree that satisfies the condition is conveniently obtained.

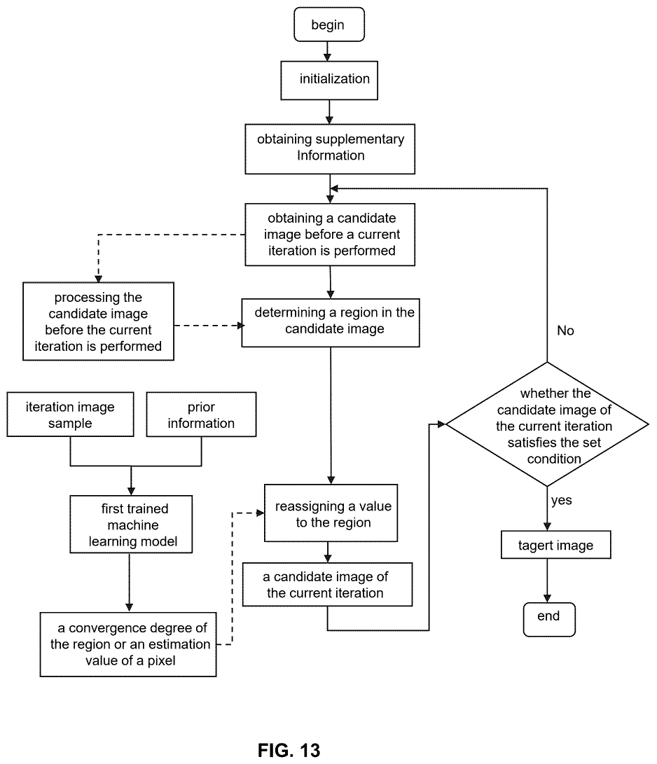

FIG. 13 is a schematic diagram illustrating an overall exemplary diagram of a method for image reconstruction according to some embodiments of the present disclosure. In some embodiments, as shown in FIG. 13, before starting an image reconstruction process, the processor performs an initialization to determine a reference iteration parameter and an initial iteration image. In some embodiments, the processor will obtain supplementary Information, for example, obtaining a subject information, an imaging device information, a scanning protocol information, and a reconstruction algorithm information.

Afterwards, the processor will obtain a candidate image before a current iteration is performed. For example, a candidate image generated in a previous iteration is used as the candidate image before the current iteration is performed. Optionally, the processor may process the candidate image before the current iteration is performed to obtain a candidate image generated in the current iteration. For example, a candidate image with a fused functional image and anatomical image is obtained.

Then, the processor determines a region of the candidate image. In some embodiments, the processor may obtain an iteration image sample, for example, obtain a fully converged iteration image sample, to train and obtain a first trained machine learning model. For example, the first trained machine learning model is trained and obtained based on the iteration image sample and a convergence degree label corresponding to the iteration image sample Optionally, the first trained machine learning model may also be trained based on the prior information. For example, the first trained machine learning model is trained based on the iteration image sample, the convergence degree label corresponding to the iteration image sample, and a prior information corresponding to the iteration image sample.

In some embodiments, based on the first trained machine learning model, a convergence degree of a region or an estimation value of a pixel can be output. A value may be reassigned to the region based on the convergence degree or the estimation value of the pixel, that is, at least one pixel value in the candidate image is updated based on the estimation value of the pixel to obtain a corrected candidate image, or, in a case where pixel values in at least one region does not satisfy a pixel threshold, pixel values in the at least one region is updated based on the convergence degree to obtain the corrected candidate image.

In some embodiments, the processor performs an iterative reconstruction process based on the corrected candidate image to obtain a candidate image for the current iteration. Then, the processor determines whether the candidate image of the current iteration satisfies the set condition. If the candidate image of the current iteration satisfies the set condition, the candidate image of the current iteration is designated as a target image. If the candidate image of the current iteration does not satisfy the set condition, the process returns to the step of obtaining the candidate image before the current iteration is performed to perform a next iterative reconstruction.

In some embodiments of the present disclosure, sub-regions are divided based on an image generated during an iteration process, and a convergence degree prediction of an image region is introduced. Pixel values in the sub-regions are updated during the iteration process according to a result of the convergence degree prediction, achieving a convergence degree control of the sub-regions during the iteration process, which can accelerate a convergence speed of the image region and improve an accuracy of the image region. In some embodiments, introducing the prior information into the convergence degree prediction process can also accelerate an image convergence.

Other embodiments of the present disclosure also provide a method for predicting a convergence degree of image reconstruction. The method includes: obtaining image data of a subject; inputting the image data into a first trained machine learning model; and outputting, via the first trained machine learning model, a convergence degree of the image data. The convergence degree is used to represent a feature difference between the image data and a corresponding target image.

In some embodiments, the method for predicting the convergence degree of image reconstruction further includes: segmenting the image data to determine at least one image patch; and inputting the at least one image patch into the first trained machine learning model to output, via the first trained machine learning model, a convergence degree of the at least one image patch.

The image patch refers to a regional image obtained by segmenting the image data. The manner of segmenting the image data is similar to the manner of segmenting the candidate image. For further description, reference may be made to operation 540 and its related description.

In some embodiments, inputting the at least one image patch into the first trained machine learning model to output the convergence degree of the at least one image patch further includes: inputting the at least one image patch and prior information into the first trained machine learning model; and outputting, via the first trained machine learning model, the convergence degree of the at least one image patch. The prior information includes patient information, scanning parameters, reconstruction parameters, and image processing parameters corresponding to the image data.

In some embodiments, the image data in the embodiments above is an intermediate image from an iterative reconstruction process; the method for predicting the convergence degree of image reconstruction further includes: in response to the convergence degree of the image data satisfying a set condition, designating the image data as a target image, the target image being a reconstructed image after the iterative reconstruction process. The target image is the reconstructed image after the iterative reconstruction process; in response to the convergence degree of the image data not satisfying the set condition, designating the image data as an initial image for a next iteration. For further details regarding the image data, the first trained machine learning model, the convergence degree, the prior information, the set condition, the initial image for the next iteration, and the adjustment of pixel values, reference may be made to FIGS. 5-13 and their related descriptions.

It should be understood that although the operations in the flowcharts involved in the above-described embodiments are shown in sequence as indicated by arrows, these operations are not necessarily executed sequentially in the order indicated by the arrows. Unless explicitly stated herein, an execution of these operations is not strictly limited in order, and these operations may be executed in other orders. Moreover, at least a portion of the operations in the flowcharts involved in the above-described embodiments may include a plurality of operations or a plurality of stages. These operations or stages are not necessarily completed at a same moment but may be executed at different moments. An execution order of these operations or stages is not necessarily sequential but may be executed in rotation or alternately with other operations or at least a portion of the operations or stages in other operations

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. As in “an embodiment”, “an embodiment”, and/or “some embodiments” means a feature, structure, or characteristic associated with at least one embodiment of the present application. Accordingly, it should be emphasized and noted that two or more references to “one embodiment” or “one embodiment” in different locations in this specification are not intended to refer to the same embodiment. In addition, some features, structures, or features in the present disclosure of one or more embodiments may be appropriately combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

Some embodiments use numbers to describe the number of components, attributes, and it should be understood that such numbers used in the description of the embodiments are modified in some examples by the modifiers “about”, “approximately”, or “substantially”. Unless otherwise noted, the terms “about,” “approximately,” or “approximately” indicates that a ±20% variation in the stated number is allowed. Correspondingly, in some embodiments, the numerical parameters used in the specification and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present application are approximations, in specific embodiments such values are set to be as precise as possible within a feasible range.

For each patent, patent application, patent application disclosure, and other material cited in this application, such as articles, books, specifications, publications, documents, etc., the entire contents of which are hereby incorporated herein by reference. Except for application history documents that are inconsistent with or conflict with the contents of this application, and except for documents (currently or hereafter appended to this application) that limit the broadest scope of the claims of this application. It should be noted that in the event of any inconsistency or conflict between the descriptions, definitions, and/or use of terms in the materials appurtenant to this application and those set forth herein, the descriptions, definitions, and/or use of terms in this application shall prevail.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A system, comprising:
at least one storage device comprising a set of instructions; and
at least one processor configured to communicate with the at least one storage device, wherein when executing the set of instructions, the at least one processor is configured to direct the system to perform operations including:
obtaining image data of a subject;
performing, based on the image data, an iterative reconstruction process including a plurality of iterations, wherein a candidate image is generated based on the image data in at least one of the plurality of iterations;
generating, based on the candidate image, a predicted result using a first trained machine learning model, the predicted result indicating a convergence of the iterative reconstruction process or a pixel value estimation of the candidate image; and
generating a target image of the subject based on the candidate image and the predicted result.

2. The system of claim 1, wherein the predicted result includes a convergence degree corresponding to each of at least one region in the candidate image, generating a target image based on the candidate image and the predicted result includes:
determining, based on the convergence degree corresponding to each of the at least one region in the candidate image, pixel values in the each of the at least one region in the target image.

3. The system of claim 1, wherein the first trained machine learning model is further configured to:
determining a pixel value estimation of the at least one region in the candidate image; and
adjusting, based on the pixel value estimation of the at least one region in the candidate image, pixel values in the at least one region in the candidate image to generate an updated candidate image corresponding to the at least one region in the candidate image, wherein the updated candidate image is designated as an initial image used in the next iteration.

4. The system of claim 1, wherein the predicted result includes a convergence degree corresponding to each of at least one region in the candidate image, generating a target image of the subject based on the candidate image and the predicted result includes:
in response to determining that the convergence degree corresponding to each of the at least one region in the candidate image satisfies a first condition, terminating the iterative reconstruction process and designating the candidate image as the target image, wherein the target image is a reconstructed image after the iterative reconstruction process; and
in response to determining that the convergence degree corresponding to at least one of the at least one region in the candidate image does not satisfy the first condition, adjusting pixel values in the at least one of the at least one region in the candidate image to generate an updated candidate image according to the convergence degree corresponding to the at least one of the at least one region in the candidate image, wherein the updated candidate image is designated as an initial image used in the next iteration.

5. The system of claim 4, wherein an input of the first trained machine learning model further comprises region segmentation information of the candidate image; the region segmentation information includes an identification indicating that at least a portion of pixels in the candidate image belongs to a target region in the at least one region, wherein the predicted result includes the convergence degree corresponding to the target region.

6. The system of claim 4, wherein the adjusting pixel values in the one of the at least one region in the candidate image to generate an updated candidate image according to the convergence degree corresponding to the one of the at least one region in the candidate image includes:
determining an adjustment amplitude for adjusting the pixel values in the one of the at least one region of the candidate image based on the convergence degree corresponding to the one of the at least one region in the candidate image; and
adjusting the pixel values in the one of the at least one region in the candidate image based on the adjustment amplitude.

7. The system of claim 1, wherein the predicted result includes an estimation value of each of at least a portion of pixels in the candidate image, and generating a target image of the subject based on the candidate image and the predicted result includes:
adjusting a pixel value of each of the at least a portion of pixels in the candidate image based on the estimation value of each of the at least a portion of pixels in the candidate image.

8. The system of claim 1, wherein an input of the first trained machine learning model further comprises at least one of a type of reconstruction algorithm of the candidate image, a count of iterations for generating the candidate image, information of the subject, or a scanning protocol for the image data.

9. The system of claim 1, wherein an input of the first trained machine learning model further comprises prior information associated with a lesion in the subject determined based on a reference image of the subject.

10. The system of claim 9, wherein the prior information is determined according to operations including:
determining the prior information by inputting the reference image into a second trained machine learning model.

11. The system of claim 1, wherein the at least one iteration is a last iteration of the iterative reconstruction process.

12. The system of claim 1, wherein the predicted result includes a confidence interval of a convergence degree corresponding to each of at least one region in the candidate image, and generating a target image of the subject based on the candidate image and the predicted result includes:
in response to determining that the confidence interval of the convergence degree corresponding to each of the at least one region in the candidate image satisfies a second condition, terminating the iterative reconstruction process and designating the candidate image as the target image; and
in response to determining that the confidence interval of the convergence degree corresponding to one of the at least one region in the candidate image does not satisfy the second condition, performing a next iteration of the at least one iteration, and designating the candidate image as an initial image used in the next iteration.

13. The system of claim 12, wherein the first trained machine learning model is obtained based on training samples, each of the training samples includes a label, the label includes a reference confidence interval determined according to operations including:
classifying the training samples into a plurality of groups based on key features of the training samples;
for each of the plurality of groups:
determining a set of convergence degrees of training samples in the group;
determining statistical features of the set of convergence degrees; and
determining the reference confidence interval based on the statistical features of the set of convergence degrees.

14. The system of claim 1, wherein the predicted result includes a convergence degree corresponding to each of the at least one region in the candidate image, an estimation value of each of at least one pixel in the candidate image, or a confidence interval of a convergence degree corresponding to each of at least one region in the candidate image, generating a target image of the subject based on the candidate image and the predicted result includes:
determining one or more state characteristics of the candidate image, where the one or more state characteristics include at least one of a global image entropy or a lesion heterogeneity value;
determining a target processing strategy from a plurality of reference processing strategies based on the one or more state characteristics; and
processing the candidate image using the target processing strategy to generate the target image.

15. The system of claim 14, wherein the plurality of reference processing strategies include:
in response to determining that the global image entropy is less than a first threshold, and the lesion heterogeneity value is less than a second threshold, adjusting a pixel value of each of the at least a portion of pixels in the candidate image based on the estimation value of each of the at least a portion of pixels in the candidate image;
in response to determining that the global image entropy is less than a first threshold, and the lesion heterogeneity value exceeds or equals the second threshold, determining the target image based on the confidence interval of the convergence degree corresponding to each of at least one region in the candidate image; and
in response to determining that the global image entropy exceeds the first threshold, determining the target image based on the convergence degree corresponding to each of the at least one region in the candidate image.

16. A method for image reconstruction, comprising:
obtaining image data of a subject;
performing, based on the image data, an iterative reconstruction process including a plurality of iterations, wherein a candidate image is generated based on the image data according to at least one of the plurality of iterations;
generating, based on the candidate image, a predicted result using a trained machine learning model, the predicted result indicating a convergence of the iterative reconstruction process or a pixel value estimation of the candidate image; and
generating a target image of the subject based on the candidate image and the predicted result.

17. A method for predicting a convergence degree of image reconstruction, comprising:
obtaining image data of a subject; and
inputting the image data into a first trained machine learning model to output, via the first trained machine learning model, a convergence degree of the image data, wherein the convergence degree represents a feature difference between the image data and a corresponding target image.

18. The method of claim 17, further comprising:
segmenting the image data to determine at least one image patch; and
inputting the at least one image patch into the first trained machine learning model to output, via the first trained machine learning model, a convergence degree of the at least one image patch.

19. The method of claim 18, wherein inputting the at least one image patch into the first trained machine learning model to output, via the first trained machine learning model, a convergence degree of the at least one image patch comprises:
inputting the at least one image patch and prior information into the first trained machine learning model to output, via the first trained machine learning model, the convergence degree of the at least one image patch;
the prior information includes patient information, scanning parameters, reconstruction parameters, and image processing parameters corresponding to the image data.

20. The method of claim 17, wherein the image data is an intermediate image generated in an iterative reconstruction process, the method further comprises:
in response to determining that the convergence degree of the image data satisfies a set condition, designating the image data as a target image, wherein the target image is a reconstructed image after the iterative reconstruction process; and
in response to determining that the convergence degree of the image data does not satisfy the set condition, designating the image data as an initial image for a next iteration.
